(19) United States
(12) Patent Application Publication
(10) Pub. No.: US 2024/0084106 A1
(43) Pub. Date: Mar. 14, 2024

(54) KNEADED MATERIAL, METHOD OF PRODUCING KNEADED MATERIAL, MOLDED BODY, AND OPTICAL MEMBER

(71) Applicant: FUJIFILM Corporation, Tokyo (JP)

(72) Inventors: Daisuke SASAKI, Shizuoka (JP); Yusuke SAKAI, Shizuoka (JP); Atsushi AZUMA, Shizuoka (JP)

(73) Assignee: FUJIFILM Corporation, Tokyo (JP)

(21) Appl. No.: 18/499,246

(22) Filed: Nov. 1, 2023

Related U.S. Application Data
(63) Continuation of application No. PCT/JP2022/023873, filed on Jun. 15, 2022.

(30) Foreign Application Priority Data
Jun. 18, 2021 (JP) 2021-101352

(51) Int. Cl. C08K 5/45; C08J 3/20

(52) U.S. Cl. CPC C08K 5/45; C08J 3/203; C08J 2323/12; C08J 2333/12; C08J 2345/00; C08J 2367/02; C08J 2369/00; C08J 2377/06; G02B 5/208

(57) ABSTRACT

Provided is a kneaded material including an ultraviolet absorbing agent that contains at least one compound selected from a compound represented by Formula (1) or a compound represented by Formula (2), and a polymer compound.

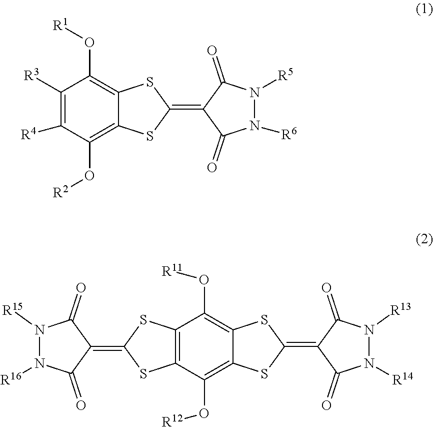

### CROSS-REFERENCE TO RELATED APPLICATIONS

This application is a Continuation of PCT International Application No. PCT/JP2022/023873 filed on Jun. 15, 2022, which claims priority under 35 U.S.C § 119(a) to Japanese Patent Application No. 2021-101352 filed on Jun. 18, 2021. Each of the above application(s) is hereby expressly incorporated by reference, in its entirety, into the present application.

### BACKGROUND OF THE INVENTION

### 1. Field of the Invention

The present invention relates to a kneaded material containing an ultraviolet absorbing agent and a polymer compound. Further, the present invention relates to a method for producing a kneaded material, a molded body, and an optical member.

### 2. Description of the Related Art

Further, attention has been paid to the influence on the retina caused by direct incidence of light having various wavelengths on human eyes, and there is a concern that particularly ultraviolet rays and blue light damage the retina and cause eye diseases. In a case of using a liquid crystal display device, an image display device such as an electroluminescent display, or a device including a display, for example, a small terminal such as a smartphone or a tablet terminal, a screen of a display including a light source is visually observed. In recent years, attention has been paid to the influence of ultraviolet rays on the retina in a case where an image display device, a small terminal, or the like is used for a long period of time. Therefore, attempts have been made to reduce the influence of ultraviolet rays on the eyes of a user by providing ultraviolet cut filters in the above-described devices and the like. An ultraviolet absorbing agent is used for such ultraviolet cut filters.

JP2009-096971A and JP2009-263616A disclose that a benzodithiol compound as an ultraviolet absorbing agent is used by being contained in a polymer compound.

### SUMMARY OF THE INVENTION

In a case where a kneaded material obtained by kneading an ultraviolet absorbing agent with a polymer compound is exposed to a high-temperature and high-humidity environment, precipitation or the like of the ultraviolet absorbing agent on a surface of the kneaded material may occur. Therefore, moist heat resistance of the kneaded material is required to be further improved.

In addition, the ultraviolet absorption performance of an ultraviolet absorbing agent may be degraded with time due to irradiation with light. In particular, an ultraviolet absorbing agent having a maximal absorption wavelength on a longer wavelength side (for example, around 380 nm) in an ultraviolet region has a tendency that the light resistance is poor and the ultraviolet absorption performance thereof is likely to be degraded with time.

Therefore, an object of the present invention is to provide a kneaded material having excellent moist heat resistance and excellent light resistance. Further, an object of the present invention is to provide a method of producing a kneaded material, a molded body, and an optical member.

The present invention provides the following aspects.
<1> A kneaded material comprising: an ultraviolet absorbing agent that contains at least one compound selected from a compound represented by Formula (1) or a compound represented by Formula (2); and a polymer compound,

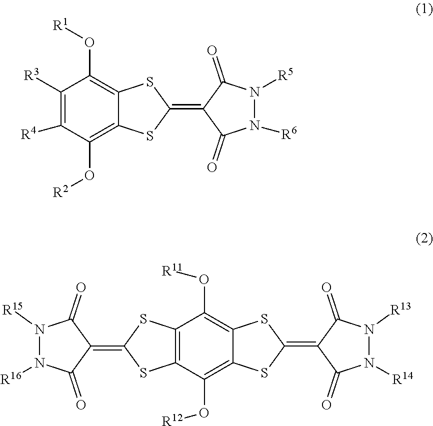

in Formula (1), R¹ and R² each independently represent a hydrogen atom, an alkyl group, an aryl group, an acyl group, a carbamoyl group, an alkoxycarbonyl group, an aryloxycarbonyl group, or an ethylenically unsaturated bond-containing group,
R³ and R⁴ each independently represent a hydrogen atom, a halogen atom, an alkyl group, an aryl group, an alkoxy group, an aryloxy group, an acyloxy group, an alkylamino group, an anilino group, an acylamino group, an alkylsulfonylamino group, an arylsulfonylamino group, an alkylthio group, an arylthio group, or an ethylenically unsaturated bond-containing group,
R⁵ and R⁶ each independently represent a hydrogen atom or a substituent,
R¹ and R³ may be bonded to each other to form a ring,
R³ and R⁴ may be bonded to each other to form a ring,
R² and R⁴ may be bonded to each other to form a ring, and
R⁵ and R⁶ may be bonded to each other to form a ring,
where at least one of R³ or R⁴ represents a halogen atom, an alkyl group, an aryl group, an alkoxy group, an aryloxy group, an acyloxy group, an alkylamino group, an anilino group, an acylamino group, an alkylsulfonylamino group, an arylsulfonylamino group, an alkylthio group, an arylthio group, or an ethylenically unsaturated bond-containing group,
in Formula (2), R¹¹ and R¹² each independently represent a hydrogen atom, an alkyl group, an aryl group, an acyl group, a carbamoyl group, an alkoxycarbonyl group, an aryloxycarbonyl group, or an ethylenically unsaturated bond-containing group,
R¹³, R¹⁴, R¹⁵, and R¹⁶ each independently represent a hydrogen atom or a substituent,
R¹³ and R¹⁴ may be bonded to each other to form a ring, and
R¹⁵ and R¹⁶ may be bonded to each other to form a ring.
<2> The kneaded material according to <1>, in which one of R³ and R⁴ in Formula (1) represents a hydrogen atom, and the other represents a halogen atom, an alkyl group, an aryl group, an alkoxy group, an aryloxy group, an acyloxy group, an alkylamino group, an anilino group, an acylamino group, an alkylsulfonylamino group, an arylsulfonylamino group, an alkylthio group, an arylthio group, or an ethylenically unsaturated bond-containing group.
<3> The kneaded material according to <1> or <2>, further comprising: a plasticizer.
<4> The kneaded material according to any one of <1> to <3>, in which the ultraviolet absorbing agent further contains a compound A having a maximal absorption wavelength on a shorter wavelength side than the compound represented by Formula (1) and the compound represented by Formula (2).
<5> The kneaded material according to <4>, in which the compound A is at least one selected from a benzotriazole compound, a triazine compound, or a benzophenone compound.
<6> The kneaded material according to any one of <1> to <5>, in which the polymer compound has a glass transition point of −80° C. or higher and 200° C. or lower.
<7> The kneaded material according to any one of <1> to <6>, in which the polymer compound is at least one selected from a (meth)acrylic resin, a polystyrene resin, a polyester resin, a polyurethane resin, a polythiourethane resin, a polyamide resin, a polyimide resin, a cyclic olefin resin, an epoxy resin, a polycarbonate resin, a vinyl polymer, or a cellulose acylate resin.
<8> The kneaded material according to any one of <1> to <7>, in which the kneaded material is a pellet.
<9> A method of producing a kneaded material, comprising: a step of kneading an ultraviolet absorbing agent that contains at least one compound selected from a compound represented by Formula (1) or a compound represented by Formula (2) with a polymer compound,

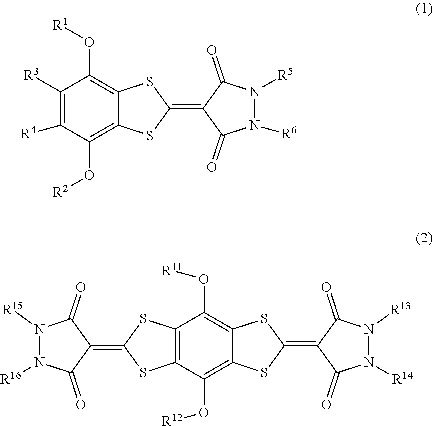

in Formula (1), R¹ and R² each independently represent a hydrogen atom, an alkyl group, an aryl group, an acyl group, a carbamoyl group, an alkoxycarbonyl group, an aryloxycarbonyl group, or an ethylenically unsaturated bond-containing group,
R³ and R⁴ each independently represent a hydrogen atom, a halogen atom, an alkyl group, an aryl group, an alkoxy group, an aryloxy group, an acyloxy group, an alkylamino group, an anilino group, an acylamino group, an alkylsulfonylamino group, an arylsulfonylamino group, an alkylthio group, an arylthio group, or an ethylenically unsaturated bond-containing group,
R⁵ and R⁶ each independently represent a hydrogen atom or a substituent,
R¹ and R³ may be bonded to each other to form a ring,
R³ and R⁴ may be bonded to each other to form a ring,
R² and R⁴ may be bonded to each other to form a ring, and
R⁵ and R⁶ may be bonded to each other to form a ring,
where at least one of R³ or R⁴ represents a halogen atom, an alkyl group, an aryl group, an alkoxy group, an aryloxy group, an acyloxy group, an alkylamino group, an anilino group, an acylamino group, an alkylsulfonylamino group, an arylsulfonylamino group, an alkylthio group, an arylthio group, or an ethylenically unsaturated bond-containing group,
in Formula (2), R¹¹ and R¹² each independently represent a hydrogen atom, an alkyl group, an aryl group, an acyl group, a carbamoyl group, an alkoxycarbonyl group, an aryloxycarbonyl group, or an ethylenically unsaturated bond-containing group,
R¹³, R¹⁴, R¹⁵, and R¹⁶ each independently represent a hydrogen atom or a substituent,
R¹³ and R¹⁴ may be bonded to each other to form a ring, and
R¹⁵ and R¹⁶ may be bonded to each other to form a ring.
<10> A molded body formed of the kneaded material according to any one of <1> to <8>.
<11> An optical member comprising: the molded body according to <10>.

According to the present invention, it is possible to provide a kneaded material having excellent moist heat resistance and excellent light resistance. Further, according to the present invention, it is possible to provide a method of producing a kneaded material, a molded body, and an optical member.

### DESCRIPTION OF THE PREFERRED EMBODIMENTS

Hereinafter, the contents of the present invention will be described in detail.

In a case where substitution or unsubstitution is not specified in the notation of a group (atomic group) in the present specification, the group includes both a group which has no substituent and a group which has a substituent. For example, “alkyl group” includes not only an alkyl group having no substituent (unsubstituted alkyl group), but also an alkyl group having a substituent (substituted alkyl group).

In the present specification, a numerical range shown using “to” indicates a range including the numerical values described before and after “to” as the lower limit value and the upper limit value.

In the present specification, the total solid content denotes the total amount of all the components of the composition excluding a solvent.

In the present specification, “(meth)acrylate” denotes both or any one of acrylate and methacrylate, “(meth)acryl” denotes both or any one of acryl and methacryl, “(meth)allyl” denotes both or any one of allyl and methallyl, and “(meth)acryloyl” denotes both or any one of acryloyl and methacryloyl .

In the present specification, the meaning of the term “step” includes not only an independent step but also a step whose intended purpose is achieved even in a case where the step is not clearly distinguished from other steps.

In the present specification, the weight-average molecular weight (Mw) and the number average molecular weight (Mn) are defined as values in terms of polystyrene, measured by gel permeation chromatography (GPC).

### Kneaded Material

A kneaded material according to the embodiment of the present invention contains an ultraviolet absorbing agent containing at least one compound selected from a compound represented by Formula (1) or a compound represented by Formula (2), and a polymer compound.

The compound represented by Formula (1) and the compound represented by Formula (2) have satisfactory kneadability, the ultraviolet absorbing agent can be substantially uniformly dispersed in the polymer compound by kneading the ultraviolet absorbing agent containing at least one compound selected from the compound represented by Formula (1) or the compound represented by Formula (2) with the polymer compound, and generation or the like of a decomposition product of the ultraviolet absorbing agent during the kneading can also be suppressed. As a result, the precipitation of the ultraviolet absorbing agent and the like from a kneaded material or a molded body formed of the kneaded material can be suppressed. Therefore, the kneaded material according to the embodiment of the present invention has excellent moist heat resistance, and a molded body having excellent moist heat resistance can be produced by using the kneaded material according to the embodiment of the present invention. The detailed reason why such an effect is obtained is unknown, but it is assumed that in the compound represented by Formula (1), at least one of R³ or R⁴ represents a predetermined group other than a hydrogen atom, and thus twisting is likely to occur due to the influence of steric repulsion or the like between R³ and R⁴. It is assumed that the effect is obtained due to a decrease in crystallinity of the compound caused by the occurrence of such twisting, and thus the compatibility between the compound and the polymer compound is improved. Further, it is assumed that in the compound represented by Formula (2), since the diffusibility (mobility) of the compound is decreased due to an increase in the molecular weight of the compound, the precipitation of the compound from a kneaded material or a molded body can be suppressed.

Further, since the compound represented by Formula (1) and the compound represented by Formula (2) have excellent light resistance and the kneaded material according to the embodiment of the present invention contains such compounds, a decrease in ultraviolet absorption performance after light irradiation can be suppressed. Therefore, the kneaded material according to the embodiment of the present invention has excellent light resistance, and thus a molded body having excellent light resistance can be produced by using the kneaded material according to the embodiment of the present invention.

Further, the compound represented by Formula (1) and the compound represented by Formula (2) have excellent absorption performance with respect to light having a wavelength of near 400 nm, and thus a molded body with excellent shielding properties with respect to light having a wavelength of around 400 nm can be produced by using the kneaded material according to the embodiment of the present invention.

In addition, since the compound represented by Formula (1) and the compound represented by Formula (2) are compounds having low fluorescence intensity, a molded body with low fluorescence intensity and excellent ultraviolet absorption performance can be produced by using such compounds as an ultraviolet absorbing agent.

In a case where the kneaded material according to the embodiment of the present invention is molded into a molded body having a thickness of 0.15 mm, the transmittance of light having a wavelength of 400 nm through the molded body is preferably 40% or less, more preferably 20% or less, and still more preferably 15% or less. Further, the transmittance of light having a wavelength of 410 nm through the molded body is preferably 60% or less, more preferably 40% or less, and still more preferably 30% or less. Further, the transmittance of light having a wavelength of 440 nm through the molded body is preferably 80% or greater, more preferably 85% or greater, and still more preferably 90% or greater.

In a case where the kneaded material according to the embodiment of the present invention is molded into a molded body having a thickness of 0.15 mm, the fluorescence intensity of the above-described molded body is preferably 10 or less, more preferably 1 or less, and still more preferably 0.1 or less. In the present specification, the fluorescence intensity is a value measured as follows. That is, the above-described molded body is irradiated with light having a maximal absorption wavelength of the ultraviolet absorbing agent as excitation light to measure an emission spectrum, the maximal fluorescence wavelength and the luminescence intensity at the maximal fluorescence wavelength are determined, and the luminescence intensity at the maximal fluorescence wavelength is defined as the fluorescence intensity. Further, in a case where the kneaded material contains two or more kinds of ultraviolet absorbing agents, light having a maximal absorption wavelength on the longest wavelength side is used as excitation light.

It is preferable that the kneaded material according to the embodiment of the present invention is a pellet. In the present specification, the pellet is a material obtained by granulating (pelletizing) the kneaded material into a certain shape such as a spherical shape, an ellipsoidal shape, a cylindrical shape, or a prismatic shape. Further, it is also preferable that the pellet is a master pellet (a masterbatch). In addition, the master pellet (the masterbatch) is a material obtained by dispersing an additive such as an ultraviolet absorbing agent having a high concentration in a polymer compound, and is used by being mixed with the polymer compound at a specified magnification in a case of forming a molded body. In general, precipitation tends to occur as the content of the ultraviolet absorbing agent in the kneaded material increases. The kneaded material according to the embodiment of the present invention is capable of suppressing precipitation or the like of the ultraviolet absorbing agent from the kneaded material even in a case where the content of the ultraviolet absorbing agent is increased. Therefore, the kneaded material according to the embodiment of the present invention can be particularly preferably used as a master pellet (masterbatch).

Further, in the present specification, the kneaded material is a material obtained by kneading an ultraviolet absorbing agent and a polymer compound. That is, the kneaded material in the present specification is obtained by mixing and dispersing an ultraviolet absorbing agent in a polymer compound. The kneaded material in the present specification is different from a solution obtained by dissolving or dispersing an ultraviolet absorbing agent and a polymer compound in a solvent.

Hereinafter, each component contained in the kneaded material will be described.

### Ultraviolet Absorbing Agent

The kneaded material according to the embodiment of the present invention contains an ultraviolet absorbing agent. The ultraviolet absorbing agent contains at least one compound selected from a compound represented by Formula (1) or a compound represented by Formula (2). Hereinafter, the compound represented by Formula (1) and the compound represented by Formula (2) will be collectively referred to as a specific compound.

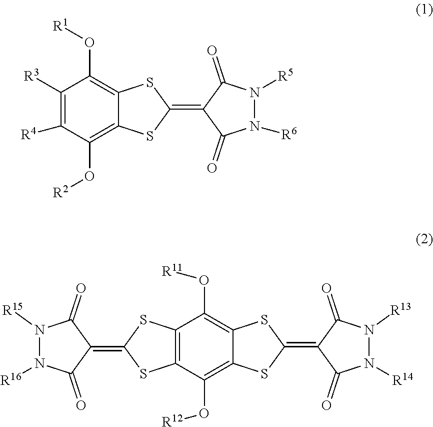

In Formula (1), R¹ and R² each independently represent a hydrogen atom, an alkyl group, an aryl group, an acyl group, a carbamoyl group, an alkoxycarbonyl group, an aryloxycarbonyl group, or an ethylenically unsaturated bond-containing group,

R³ and R⁴ each independently represent a hydrogen atom, a halogen atom, an alkyl group, an aryl group, an alkoxy group, an aryloxy group, an acyloxy group, an alkylamino group, an anilino group, an acylamino group, an alkylsulfonylamino group, an arylsulfonylamino group, an alkylthio group, an arylthio group, or an ethylenically unsaturated bond-containing group,

R⁵ and R⁶ each independently represent a hydrogen atom or a substituent,

R¹ and R³ may be bonded to each other to form a ring,

R³ and R⁴ may be bonded to each other to form a ring,

R² and R⁴ may be bonded to each other to form a ring, and

R⁵ and R⁶ may be bonded to each other to form a ring,

where at least one of R³ or R⁴ represents a halogen atom, an alkyl group, an aryl group, an alkoxy group, an aryloxy group, an acyloxy group, an alkylamino group, an anilino group, an acylamino group, an alkylsulfonylamino group, an arylsulfonylamino group, an alkylthio group, an arylthio group, or an ethylenically unsaturated bond-containing group,

in Formula (2), R¹¹ and R¹² each independently represent a hydrogen atom, an alkyl group, an aryl group, an acyl group, a carbamoyl group, an alkoxycarbonyl group, an aryloxycarbonyl group, or an ethylenically unsaturated bond-containing group,

R¹³, R¹⁴, R¹⁵, and R¹⁶ each independently represent a hydrogen atom or a substituent,

R 13 and R 14 may be bonded to each other to form a ring, and

R¹⁵ and R¹⁶ may be bonded to each other to form a ring.

As the alkyl group represented by R¹ and R² in Formula (1) and an alkyl group represented by R¹¹ and R¹² in Formula (2), an alkyl group having 1 to 30 carbon atoms is preferable, an alkyl group having 1 to 20 carbon atoms is more preferable, an alkyl group having 1 to 15 carbon atoms is still more preferable, and an alkyl group having 1 to 10 carbon atoms is particularly preferable. The alkyl group may be linear, branched, or cyclic, but it is preferable that the alkyl group is a linear or branched alkyl group. The alkyl group may have a substituent. Examples of the substituent include the groups described in the section of the substituent T below. Among these, an alkoxy group, an aryloxy group, an acyl group, an acyloxy group, an alkoxycarbonyl group, and an aryloxycarbonyl group are preferable, and an alkoxycarbonyl group is more preferable. Specific examples of the alkyl group include a methyl group, an ethyl group, an n-propyl group, an isopropyl group, a sec-butyl group, a tert-butyl group, an n-hexyl group, an n-octyl group, an n-decyl group, an eicosyl group, a 2-chloroethyl group, a 2-cyanoethyl group, a benzyl group, a 2-ethylbutyl group, a 2-ethylhexyl group, a 3,5,5-trimethylhexyl group, a 2-hexyldecyl group, a 2-octyldecyl group, a 2-(4,4-dimethylpentane-2-yl)-5,7,7-trimethyloctyl group, an isostearyl group, an isopalmityl group, a vinyl group, an allyl group, a prenyl group, a geranyl group, an oleyl group, a propargyl group, a cyclohexyl group, a cyclopentyl group, an ethoxycarbonylpropyl group, an ethoxycarbonylpentyl group, a butoxycarbonylpropyl group, and a 2-ethylhexyloxycarbonylpropyl group.

The aryl group represented by R¹ and R² in Formula (1) and the aryl group represented by R¹¹ and R¹² in Formula (2) are preferably an aryl group having 6 to 30 carbon atoms and more preferably an aryl group having 6 to 10 carbon atoms. The aryl group may have a substituent. Examples of the substituent include the groups described in the section of the substituent T below. Specific examples of the aryl group include a phenyl group, a p-tolyl group, a naphthyl group, a meta-chlorophenyl group, and an orthohexadecanoylaminophenyl group. A phenyl group is preferable as the aryl group.

As the acyl group represented by R¹ and R² in Formula (1) and the acyl group represented by R¹¹ and R¹² in Formula (2), an acyl group having 2 to 30 carbon atoms is preferable. The acyl group may have a substituent. Examples of the substituent include the groups described in the section of the substituent T below. Specific examples of the acyl group include an acetyl group, a pivaloyl group, a 2-ethylhexanoyl group, a stearoyl group, a benzoyl group, and a p-methoxyphenylcarbonyl group.

As the carbamoyl group represented by R¹ and R² in Formula (1) and the carbamoyl group represented by R¹¹ and R¹² of Formula (2), a carbamoyl group having 1 to 30 carbon atoms is preferable. The carbamoyl group may have a substituent. Examples of the substituent include the groups described in the section of the substituent T below. Specific examples of the carbamoyl group include a N,N-dimethylcarbamoyl group, a N,N-diethylcarbamoyl group, a morpholinocarbonyl group, a N,N-di-n-octylaminocarbonyl group, and a N-n-octylcarbamoyl group.

Examples of the alkoxycarbonyl group represented by R¹ and R² in Formula (1) and the alkoxycarbonyl group represented by R¹¹ and R¹² in Formula (2) include an alkoxycarbonyl group having 2 to 30 carbon atoms. The alkoxycarbonyl group may have a substituent. Examples of the substituent include the groups described in the section of the substituent T below.

Examples of the aryloxycarbonyl group represented by R¹ and R² in Formula (1) and the aryloxycarbonyl group represented by R¹¹ and R¹² in Formula (2) include an aryloxycarbonyl group having 7 to 30 carbon atoms. The aryloxycarbonyl group may have a substituent. Examples of the substituent include the groups described in the section of the substituent T below.

Examples of the ethylenically unsaturated bond-containing group represented by R¹ and R² in Formula (1) and the ethylenically unsaturated bond-containing group represented by R¹¹ and R¹² in Formula (2) include a vinyl group, a (meth)allyl group, a (meth)acryloyl group, a (meth)acryloyloxy group, a (meth)acryloylamino group, a vinylphenyl group, and a group represented by Formula (R100).

*—X^{R1}—Y^{R1}—Z^{R1} (R100)

In Formula (R100), X^{R1} represents a single bond, —C(═O )—^{*1}, —C(═O)O—^{*1}, or —C(═O )NRx¹-^{*1}, where Rx¹ represents a hydrogen atom, an alkyl group, or an aryl group and -^{*1} represents a bonding site with respect to Y^{R1}, Y^{R1} represents a single bond or a divalent linking group, and Z^{R1} represents a vinyl group, a (meth)allyl group, a (meth)acryloyl group, a (meth)acryloyloxy group, a (meth)acryloylamino group, or a vinylphenyl group.

As the alkyl group represented by Rx¹, an alkyl group having 1 to 30 carbon atoms is preferable. Specific examples thereof include a methyl group, an ethyl group, an n-propyl group, an isopropyl group, and an n-butyl. As the aryl group represented by Rx¹, a substituted or unsubstituted aryl group having 6 to 30 carbon atoms is preferable. Specific examples thereof include a phenyl group, a p-tolyl group, and a naphthyl group. It is preferable that Rx¹ represents a hydrogen atom.

It is preferable that X^{R1} represents —C(═O)NH—^{*1}.

Examples of the divalent linking group represented by Y^{R1} include a hydrocarbon group, —NH—, —S(═O)₂—, —O—, —C(═O)—, —OC(═O)—, —C(═O)O—, —NHC(═O)—, —C(═O)NH—, and a group formed by combining two or more of these groups. Examples of the hydrocarbon group include an aliphatic hydrocarbon group and an aromatic hydrocarbon group, and an aliphatic hydrocarbon group is preferable. The number of carbon atoms of the aliphatic hydrocarbon group is preferably in a range of 1 to 30, more preferably in a range of 1 to 20, and still more preferably in a range of 1 to 15. The aliphatic hydrocarbon group may be linear, branched, or cyclic. Further, the cyclic aliphatic hydrocarbon group may be a monocycle or a fused ring. Further, the cyclic aliphatic hydrocarbon group may have a crosslinking structure. The number of carbon atoms of the aromatic hydrocarbon group is preferably in a range of 6 to 30, more preferably in a range of 6 to 20, and still more preferably in a range of 6 to 10. The hydrocarbon group may have a substituent. Examples of the substituent include the substituent T described below. Examples of the substituent include a hydroxy group.

It is preferable that the divalent linking group represented by Y^{R1} is a hydrocarbon group or a group formed by linking two or more hydrocarbon groups via a single bond or a divalent linking group. Examples of the linking group that links two or more of the hydrocarbon groups include —NH—, —S(═O)₂—, —O—, —C(═O)—, —OC(═O)—, —C(═O)O—, —NHC(═O)—, and —C(═O)NH—. Among these, —O—, —C(═O)—, —OC(═O)—, —C(═O)O—, —NHC(═O)—, or —C(═O)NH— is preferable.

Z^{R1} represents preferably a (meth)acryloyloxy group or a vinylphenyl group and more preferably a (meth)acryloyloxy group.

It is preferable that R¹ and R² in Formula (1) and R¹¹ and R¹² in Formula (2) each independently represent an alkyl group, an acyl group, a carbamoyl group, or an ethylenically unsaturated bond-containing group.

Examples of the halogen atom represented by R³ and R⁴ of Formula (1) include a fluorine atom, a chlorine atom, and a bromine atom.

As the alkyl group represented by R³ and R⁴ in Formula (1), an alkyl group having 1 to 30 carbon atoms is preferable, an alkyl group having 1 to 10 carbon atoms is more preferable, an alkyl group having 1 to 5 carbon atoms is still more preferable, and an alkyl group having 1 or 2 carbon atoms is particularly preferable. The alkyl group is preferably a linear or branched alkyl group and more preferably a linear alkyl group. The alkyl group may have a substituent. Examples of the substituent include the groups described in the section of the substituent T below. Specific examples of the alkyl group include a methyl group, an ethyl group, an n-propyl group, an isopropyl group, a tert-butyl group, an n-octyl group, a 2-cyanoethyl group, a benzyl group, a 2-ethylhexyl group, a vinyl group, an allyl group, a prenyl group, a geranyl group, an oleyl group, a propargyl group, a cyclohexyl group, a cyclopentyl group, a 2-hydroxyethyl group, and a 2-hydroxypropyl group. Among these, a methyl group and a tert-butyl group are preferable, and a methyl group is more preferable from the viewpoint of ease of synthesis.

As the aryl group represented by R³ and R⁴ in Formula (1), an aryl group having 6 to 30 carbon atoms is preferable, and an aryl group having 6 to 10 carbon atoms is more preferable. The aryl group may have a substituent. Examples of the substituent include the groups described in the section of the substituent T below. Specific examples of the aryl group include a phenyl group, a p-tolyl group, and a naphthyl group.

As the alkoxy group represented by R³ and R⁴ in Formula (1), an alkoxy group having 1 to 30 carbon atoms is preferable. The alkoxy group may have a substituent. Examples of the substituent include the groups described in the section of the substituent T below. Specific examples of the alkoxy group include a methoxy group and an ethoxy group.

As the aryloxy group represented by R³ and R⁴ in Formula (1), an aryloxy group having 6 to 30 carbon atoms is preferable. The aryloxy group may have a substituent. Examples of the substituent include the groups described in the section of the substituent T below. Specific examples of the aryloxy group include a phenoxy group, a 2-methylphenoxy group, a 4-tert-butylphenoxy group, a 3-nitrophenoxy group, and a 2-tetradecanoylaminophenoxy group.

As the acyloxy group represented by R³ and R⁴ in Formula (1), an acyloxy group having 2 to 30 carbon atoms is preferable. The acyloxy group may have a substituent. Examples of the substituent include the groups described in the section of the substituent T below.

As the alkylamino group represented by R³ and R⁴ in Formula (1), an alkylamino group having 1 to 30 carbon atoms is preferable. The alkylamino group may have a substituent. Examples of the substituent include the groups described in the section of the substituent T below.

As the anilino group represented by R³ and R⁴ in Formula (1), an anilino group having 6 to 40 carbon atoms is preferable, an anilino group having 6 to 30 carbon atoms is more preferable, an anilino group having 6 to 20 carbon atoms is still more preferable, an anilino group having 6 to 15 carbon atoms is particularly preferable, and an anilino group having 6 to 12 carbon atoms is most preferable. The anilino group may have a substituent. Examples of the substituent include groups described in the section of the substituent T described below.

As the acylamino group represented by R³ and R⁴ in Formula (1), an acylamino group having 2 to 30 carbon atoms is preferable, an acylamino group having 2 to 20 carbon atoms is more preferable, an acylamino group having 2 to 15 carbon atoms is still more preferable, and an acylamino group having 2 to 10 carbon atoms is particularly preferable. The acylamino group may have a substituent. Examples of the substituent include groups described in the section of the substituent T described below.

As the alkylsulfonylamino group represented by R³ and R⁴ in Formula (1), an alkylsulfonylamino group having 2 to 30 carbon atoms is preferable, an alkylsulfonylamino group having 2 to 20 carbon atoms is more preferable, an alkylsulfonylamino group having 2 to 15 carbon atoms is still more preferable, and an alkylsulfonylamino group having 2 to 10 carbon atoms is particularly preferable. The alkylsulfonylamino group may have a substituent. Examples of the substituent include groups described in the section of the substituent T described below.

As the arylsulfonylamino group represented by R³ and R⁴ in Formula (1), an arylsulfonylamino group having 6 to 40 carbon atoms is preferable, an arylsulfonylamino group having 6 to 30 carbon atoms is more preferable, an arylsulfonylamino group having 6 to 20 carbon atoms is still more preferable, an arylsulfonylamino group having 6 to 15 carbon atoms is particularly preferable, and an arylsulfonylamino group having 6 to 12 carbon atoms is most preferable. The arylsulfonylamino group may have a substituent. Examples of the substituent include groups described in the section of the substituent T described below.

As the alkylthio group represented by R³ and R⁴ in Formula (1), an alkylthio group having 1 to 30 carbon atoms is preferable, an alkylthio group having 1 to 20 carbon atoms is more preferable, an alkylthio group having 1 to 15 carbon atoms is still more preferable, an alkylthio group having 1 to 10 carbon atoms is particularly preferable, and an alkylthio group having 1 to 8 carbon atoms is most preferable. The alkylthio group may be linear or branched. The alkylthio group may have a substituent. Examples of the substituent include groups described in the section of the substituent T described below.

As the arylthio group represented by R³ and R⁴ in Formula (1), an arylthio group having 6 to 40 carbon atoms is preferable, an arylthio group having 6 to 30 carbon atoms is more preferable, an arylthio group having 6 to 20 carbon atoms is still more preferable, an arylthio group having 6 to 15 carbon atoms is particularly preferable, and an arylthio group having 6 to 12 carbon atoms is most preferable. The arylthio group may have a substituent. Examples of the substituent include groups described in the section of the substituent T described below.

Examples of the ethylenically unsaturated bond-containing group represented by R³ and R⁴ in Formula (1) include the groups described as the ethylenically unsaturated bond-containing group represented by R¹ and R² in Formula (1) and the ethylenically unsaturated bond-containing group represented by R¹¹ and R¹² in Formula (2).

At least one of R³ or R⁴ in Formula (1) represents a halogen atom, an alkyl group, an aryl group, an alkoxy group, an aryloxy group, an acyloxy group, an alkylamino group, an anilino group, an acylamino group, an alkylsulfonylamino group, an arylsulfonylamino group, an alkylthio group, an arylthio group, or an ethylenically unsaturated bond-containing group. Among these, from the viewpoint of suppressing precipitation or the like after kneading with a polymer compound, an alkyl group, an alkoxy group, or an aryloxy group is preferable.

Further, from the viewpoint of suppressing precipitation or the like after kneading with a polymer compound, it is preferable that one of R³ and R⁴ in Formula (1) represents a hydrogen atom and the other represents a halogen atom, an alkyl group, an aryl group, an alkoxy group, an aryloxy group, an acyloxy group, an alkylamino group, an anilino group, an acylamino group, an alkylsulfonylamino group, an arylsulfonylamino group, an alkylthio group, an arylthio group, or an ethylenically unsaturated bond-containing group, more preferable that one of R³ and R⁴ represents a hydrogen atom and the other represents an alkyl group, an alkoxy group, or an aryloxy group, and still more preferable that one of R³ and R⁴ represents a hydrogen atom and the other represents an alkyl group.

In Formula (1), R¹ and R³ may be bonded to each other to form a ring, R³ and R⁴ may be bonded to each other to form a ring, and R² and R⁴ may be bonded to each other to form a ring. It is preferable that the ring formed by these groups being bonded to each other is a 5- or 6-membered ring. The ring to be formed may have a substituent. Examples of the substituent include groups described in the section of the substituent T described below. Examples of the substituent represented by R⁵ and R⁶ in Formula (1) and R¹³, R¹⁴, R¹⁵, and R¹⁶ in Formula (2) include the groups described in the section of the substituent T below. Among these, an alkyl group, an aryl group, or a heterocyclic group is preferable, an alkyl group or an aryl group is more preferable, and an alkyl group is still more preferable.

The alkyl group is preferably an alkyl group having 1 to 30 carbon atoms, more preferably an alkyl group having 1 to 20 carbon atoms, still more preferably an alkyl group having 1 to 15 carbon atoms, particularly preferably an alkyl group having 1 to 10 carbon atoms, and most preferably an alkyl group having 1 to 8 carbon atoms. The alkyl group may be linear, branched, or cyclic and preferably linear or branched. The alkyl group may have a substituent. Examples of the substituent include groups described in the section of the substituent T described below.

The aryl group is preferably an aryl group having 6 to 40 carbon atoms, more preferably an aryl group having 6 to 30 carbon atoms, still more preferably an aryl group having 6 to 20 carbon atoms, particularly preferably an aryl group having 6 to 15 carbon atoms, and most preferably an aryl group having 6 to 12 carbon atoms. As the aryl group, a phenyl group or a naphthyl group is preferable, and a phenyl group is more preferable. Further, the aryl group may have a substituent. Examples of the substituent include groups described in the section of the substituent T described below.

It is preferable that the heterocyclic ring in the heterocyclic group includes a 5- or 6-membered saturated or unsaturated heterocyclic ring. The heterocyclic ring may be fused with an aliphatic ring, an aromatic ring, or another heterocyclic ring. Examples of the heteroatom constituting the ring of the heterocyclic ring include B, N, O, S, Se, and Te. Among these, N, O and S are preferable. It is preferable that the carbon atom of the heterocyclic ring has a free valence (monovalent) (the heterocyclic group is bonded at the carbon atom). The number of carbon atoms of the heterocyclic group is preferably in a range of 1 to 40, more preferably in a range of 1 to 30, and still more preferably in a range of 1 to 20. Examples of the saturated heterocyclic ring in the heterocyclic group include a pyrrolidine ring, a morpholine ring, a 2-bora-1,3-dioxolane ring, and a 1,3-thiazolidine ring. Examples of the unsaturated heterocyclic ring in the heterocyclic group include an imidazole ring, a thiazole ring, a benzothiazole ring, a benzoxazole ring, a benzotriazole ring, a benzoselenazole ring, a pyridine ring, a pyrimidine ring, and a quinoline ring. The heterocyclic group may have a substituent. Examples of the substituent include groups described in the section of the substituent T described below.

R⁵ and R⁶ in Formula (1) may be bonded to each other to form a ring, R¹³ and R¹⁴ in Formula (2) may be bonded to each other to form a ring, and R¹⁵ and R¹⁶ in Formula (2) may be bonded to each other to form a ring. It is preferable that the ring formed by these groups being bonded to each other is a 5- or 6-membered ring. Specific examples of the ring include a hexahydropyridazine ring, a tetrahydropyridazine ring, and a tetrahydrophthalazine ring. The ring to be formed may have a substituent. Examples of the substituent include groups described in the section of the substituent T described below.

R⁵ and R⁶ in Formula (1) and R¹³, R¹⁴, R¹⁵, and R¹⁶ in Formula (2) each independently represent preferably a hydrogen atom, an alkyl group, an aryl group, or a heterocyclic group, more preferably an alkyl group or an aryl group, and still more preferably an alkyl group.

(Substituent T)

Examples of the substituent T include the following groups.

Examples thereof include a halogen atom (such as a chlorine atom, a bromine atom, or an iodine atom), an alkyl group [a linear, branched, or cyclic alkyl group, specific examples thereof include a linear or branched alkyl group (preferably a linear or branched alkyl group having 1 to 30 carbon atoms, and examples thereof include a methyl group, an ethyl group, an n-propyl group, an isopropyl group, a t-butyl group, an n-octyl group, an eicosyl group, a 2-chloroethyl group, a 2-cyanoethyl group, and a 2-ethylhexyl group), a cycloalkyl group (preferably a cycloalkyl group having 3 to 30 carbon atoms, and examples thereof include a cyclohexyl group, a cyclopentyl group, and a 4-n-dodecylcyclohexyl group), a bicycloalkyl group (preferably a bicycloalkyl group having 5 to 30 carbon atoms, that is, a monovalent group obtained by removing one hydrogen atom from a bicycloalkane having 5 to 30 carbon atoms, and examples thereof include a bicyclo[1,2,2]heptane-2-yl group and a bicyclo[2,2,2]octane-3-yl group), and those having a tricyclo structure with a plurality of ring structures, and alkyl groups in the substituents described below (for example, an alkyl group in an alkylthio group) are alkyl groups of such a concept], an alkenyl group [linear, branched, or cyclic alkenyl group, specific examples thereof include a linear or branched alkenyl group (preferably a linear or branched alkenyl group having 2 to 30 carbon atoms, and examples thereof include a vinyl group, an allyl group, a prenyl group, a geranyl group, and an oleyl group), a cycloalkenyl group (preferably a cycloalkenyl group having 3 to 30 carbon atoms, that is, a monovalent group obtained by removing one hydrogen atom from a cycloalkene having 3 to 30 carbon atoms, and examples thereof include a 2-cyclopentene-1-yl group and a 2-cyclohexene-1-yl group), and a bicycloalkenyl group (preferably a bicycloalkenyl group having 5 to 30 carbon atoms, that is, a monovalent group obtained by removing one hydrogen atom from a bicycloalkene having one double bond, and examples thereof include a bicyclo[2,2,1]hepto-2-en-1-yl group and a bicyclo[2,2,2]octo-2-en-4-yl group)], an alkynyl group (preferably a linear or branched alkynyl group having 2 to 30 carbon atoms, examples thereof include an ethynyl group and a propargyl group),

an aryl group (preferably an aryl group having 6 to 30 carbon atoms, and examples thereof include a phenyl group, a p-tolyl group, a naphthyl group, an m-chlorophenyl group, an o-hexadecanoylaminophenyl group), a heterocyclic group (preferably a monovalent group obtained by removing one hydrogen atom from a 5- or 6-membered aromatic or non-aromatic heterocyclic compound and more preferably a 5- or 6-membered aromatic heterocyclic group having 1 to 20 carbon atoms, and examples thereof include a 2-furyl group, a 2-thienyl group, a 2-pyrimidinyl group, and a 2-benzothiazolyl group), a cyano group, a hydroxy group, a nitro group, a carboxyl group, an alkoxy group (preferably a linear or branched alkoxy group having 1 to 30 carbon atoms, and examples thereof include a methoxy group, an ethoxy group, an isopropoxy group, a t-butoxy group, an n-octyloxy group, and a 2-methoxyethoxy group), an aryloxy group (preferably an aryloxy group having 6 to 30 carbon atoms, and examples thereof include a phenoxy group, a 2-methylphenoxy group, a 4-t-butylphenoxy group, a 3-nitrophenoxy group, and a 2-tetradecanoylaminophenoxy group), a heterocyclic oxy group (preferably a heterocyclic oxy group having 2 to 30 carbon atoms, and examples thereof include a 1-phenyltetrazole-5-oxy group and a 2-tetrahydropyranyloxy group), an acyloxy group (preferably a formyloxy group, an alkylcarbonyloxy group having 2 to 30 carbon atoms, or an arylcarbonyloxy group having 6 to 30 carbon atoms, and examples thereof include a formyloxy group, an acetyloxy group, a pivaloyloxy group, a stearoyloxy group, a benzoyloxy group, and a p-methoxyphenylcarbonyl oxy group),

a carbamoyloxy group (preferably a carbamoyloxy group having 1 to 30 carbon atoms, and examples thereof include a N,N-dimethylcarbamoyloxy group, a N,N-diethylcarbamoyloxy group, a morpholinocarbonyloxy group, a N,N-di-n-octylaminocarbonyloxy group, and a N-n-octycarbamoyloxygroup), an alkoxycarbonyloxy group (preferably an alkoxycarbonyloxy group having 2 to 30 carbon atoms, and examples thereof include a methoxycarbonyloxy group, an ethoxycarbonyloxy group, a t-butoxycarbonyloxy group, and an n-octylcarbonyloxy group), an aryloxycarbonyloxy group (preferably an aryloxycarbonyloxy group having 7 to 30 carbon atoms, and examples thereof include a phenoxycarbonyloxy group, a p-methoxyphenoxycarbonyloxy group, and a p-n-hexadecyloxyphenoxycarbonyloxy group), an amino group (preferably an amino group, an alkylamino group having 1 to 30 carbon atoms, or an anilino group having 6 to 30 carbon atoms, and examples thereof include an amino group, a methylamino group, a dimethylamino group, an anilino group, a N-methyl-anilino group, and a diphenylamino group), an acylamino group (preferably a formylamino group, an alkylcarbonylamino group having 2 to 30 carbon atoms, or an arylcarbonylamino group having 6 to 30 carbon atoms, and examples thereof include a formylamino group, an acetylamino group, a pivaloylamino group, a lauroylamino group, a benzoylamino group, and a 3,4,5-tri-n-octyloxyphenylcarbonylamino group),

an aminocarbonylamino group (preferably an aminocarbonylamino group having 1 to 30 carbon atoms, and examples thereof include a carbamoylamino group, a N,N-dimethylaminocarbonylamino group, a N,N-diethylaminocarbonylamino group, and a morpholinocarbonylamino group), an alkoxycarbonylamino group (preferably an alkoxycarbonylamino group having 2 to 30 carbon atoms, and examples thereof include a methoxycarbonylamino group, an ethoxycarbonylamino group, a t-butoxycarbonylamino group, an n-octadecyloxycarbonylamino group, and a N-methyl-methoxycarbonylamino group), an aryloxycarbonylamino group (preferably an aryloxycarbonylamino group having 7 to 30 carbon atoms, and examples thereof include a phenoxycarbonylamino group, a p-chlorophenoxycarbonylamino group, and an m-n-octyloxyphenoxycarbonylamino group), a sulfamoylamino group (preferably a sulfamoylamino group having 0 to 30 carbon atoms, and examples thereof include a sulfamoylamino group, a N,N-dimethylaminosulfonylamino group, and a N-n-octylaminosulfonylamino group), an alkyl or arylsulfonylamino group (preferably an alkyl sulfonylamino group having 1 to 30 carbon atoms or an arylsulfonylamino group having 6 to 30 carbon atoms, and examples thereof include a methylsulfonylamino group, a butyl sulfonylamino group, a phenyl sulfonylamino group, a 2,3,5-trichlorophenylsulfonylamino group, and a p-methylphenylsulfonylamino group), a mercapto group, an alkylthio group (preferably an alkylthio group having 1 to 30 carbon atoms, and examples thereof include a methylthio group, an ethylthio group, and an n-hexadecylthio group), an arylthio group (preferably an arylthio group having 6 to 30 carbon atoms, and examples thereof include a phenylthio group, a p-chlorophenylthio group, and an m-methoxyphenylthio group), a heterocyclic thio group (preferably a heterocyclic thio group having 2 to 30 carbon atoms, and examples thereof include a 2-benzothiazolylthio group and a 1-phenyltetrazole-5-ylthio group),

a sulfamoyl group (preferably a sulfamoyl group having 0 to 30 carbon atoms, and examples thereof include a N-ethylsulfamoyl group, a N-(3-dodecyloxypropyl)sulfamoyl group, a N,N-dimethylsulfamoyl group, a N-acetylsulfamoyl group, a N-benzoylsulfamoyl group, a N-(N′-phenylcarbamoyl)sulfamoyl group), a sulfo group, an alkyl or arylsulfinyl group (preferably an alkyl sulfinyl group having 1 to 30 carbon atoms or an arylsulfinyl group having 6 to 30 carbon atoms, and examples thereof include a methylsulfinyl group, an ethylsulfinyl group, a phenylsulfinyl group, and a p-methylphenylsulfinyl group), an alkyl or arylsulfonyl group (preferably an alkylsulfonyl group having 1 to 30 carbon atoms or an arylsulfonyl group having 6 to 30 carbon atoms, and examples thereof include a methylsulfonyl group, an ethylsulfonyl group, a phenylsulfonyl group, and a p-methylphenylsulfonyl group),

an acyl group (preferably a formyl group, an alkylcarbonyl group having 2 to 30 carbon atoms, an arylcarbonyl group having 7 to 30 carbon atoms, or a heterocyclic carbonyl group having 4 to 30 carbon atoms and bonded to a carbonyl group, and examples include an acetyl group, a pivaloyl group, a 2-chloroacetyl group, a stearoyl group, a benzoyl group, a p-n-octyloxyphenylcarbonyl group, a 2-pyridylcarbonyl group, and a 2-furyl carbonyl group), an aryloxycarbonyl group (preferably an aryloxycarbonyl group having 7 to 30 carbon atoms, and examples thereof include a phenoxycarbonyl group, an o-chlorophenoxycarbonyl group, an m-nitrophenoxycarbonyl group, and a p-t-butylphenoxycarbonyl group), an alkoxycarbonyl group (preferably an alkoxycarbonyl group having 2 to 30 carbon atoms, and examples thereof include a methoxycarbonyl group, an ethoxycarbonyl group, a t-butoxycarbonyl group, an n-octadecyloxycarbonyl group, an n-butoxycarbonyl group, and a 2-ethylhexyloxycarbonyl group), a carbamoyl group (preferably a carbamoyl group having 1 to 30 carbon atoms, and examples thereof include a carbamoyl group, a N-methylcarbamoyl group, a N,N-dimethylcarbamoyl group, a N,N-di-n-octylcarbamoyl group, and a N-(methylsulfonyl)carbamoyl group), an aryl or heterocyclic azo group (preferably an arylazo group having 6 to 30 carbon atoms or a heterocyclic azo group having 3 to 30 carbon atoms, and examples thereof include a phenylazo group, a p-chlorophenylazo group, and a 5-ethylthio-1,3,4-thiadiazole-2-ylazo group), an imide group (preferably a N-succinimide group or a N-phthalimide group), a phosphino group (preferably a phosphino group having 2 to 30 carbon atoms, and examples thereof include a dimethylphosphino group, a diphenylphosphino group, and a methylphenoxyphosphino group), a phosphinyl group (preferably a phosphinyl group having 2 to 30 carbon atoms, and examples thereof include a phosphinyl group, a dioctyloxyphosphinyl group, and a diethoxyphosphinyl group), a phosphinyloxy group (preferably a phosphinyloxy group having 2 to 30 carbon atoms, and examples thereof include a diphenoxyphosphinyloxy group and a dioctyloxyphosphinyloxy group), a phosphinylamino group (preferably a phosphinylamino group having 2 to 30 carbon atoms, and examples thereof include a dimethoxyphosphinylamino group and a dimethylaminophosphinylamino group), and an ethylenically unsaturated bond-containing group (examples thereof include a vinyl group, a (meth)allyl group, a (meth)acryloyl group, a (meth)acryloyloxy group, a (meth)acryloylamino group, and a vinylphenyl group).

Among the groups described above, one or more hydrogen atoms of groups having hydrogen atoms may be substituted with the above-described substituents T. Examples of such substituents include an alkylcarbonylaminosulfonyl group, an arylcarbonylaminosulfonyl group, an alkylsulfonylaminocarbonyl group, and an arylsulfonylaminocarbonyl group. Specific examples include a methylsulfonylaminocarbonyl group, a p-methylphenylsulfonylaminocarbonyl group, an acetylaminosulfonyl group, and a benzoylaminosulfonyl group.

The specific compound has a maximal absorption wavelength preferably in a wavelength range of 360 to 430 nm, more preferably in a wavelength range of 370 to 420 nm, still more preferably in a wavelength range of 380 to 420 nm, and particularly preferably in a wavelength range of 380 to 405 nm.

The molar absorption coefficient of the specific compound at the maximal absorption wavelength is preferably 10,000 L/mol·cm or greater, more preferably 20,000 L/mol·cm or greater, and still more preferably 30,000 L/mol·cm or greater.

Further, the molar absorption coefficient of the specific compound at a wavelength of 400 nm is preferably 1,000 L/mol·cm or greater, more preferably 3,000 L/mol·cm or greater, and still more preferably 5,000 L/mol·cm or greater.

The maximal absorption wavelength and the molar absorption coefficient of the specific compound can be determined by measuring the spectral spectrum of a solution, prepared by dissolving the specific compound in ethyl acetate, at room temperature (25° C.) using a 1 cm quartz cell. Examples of the measuring device include UV-1800PC (manufactured by Shimadzu Corporation).

The specific compound can be produced in conformity with the methods described in JP2009-067984A, JP2009-263616A, JP2009-263617A, and WO2017/122503A.

Specific examples of the specific compound include compounds having the following structures. In the structural formulae shown below, Me represents a methyl group, Et represents an ethyl group, Pr represents a propyl group, Bu represents a butyl group, tBu represents a tert-butyl group, and Ph represents a phenyl group.

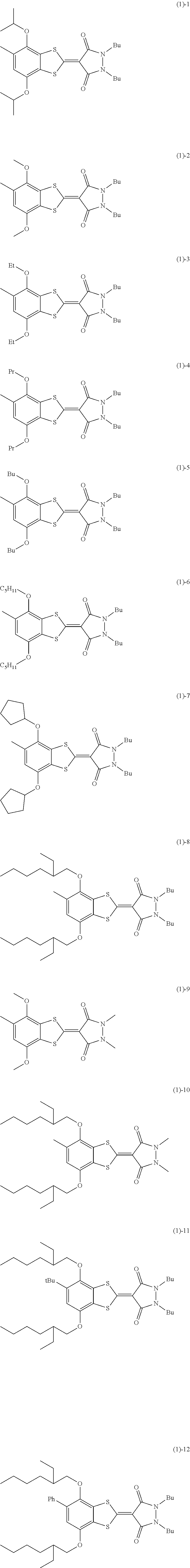

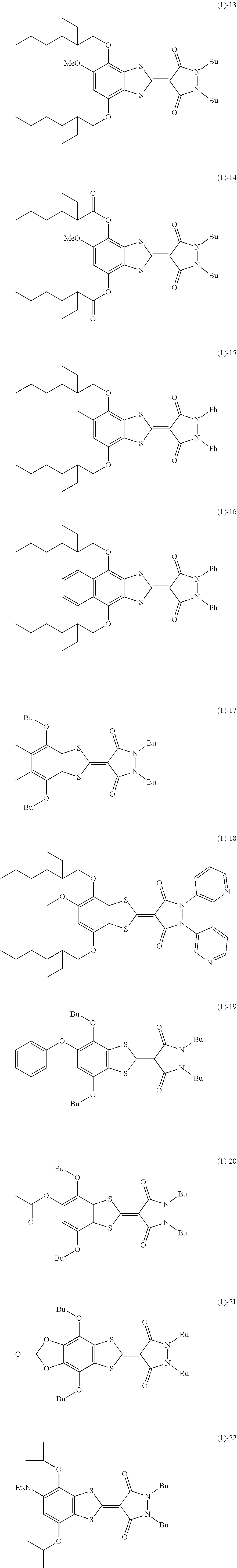

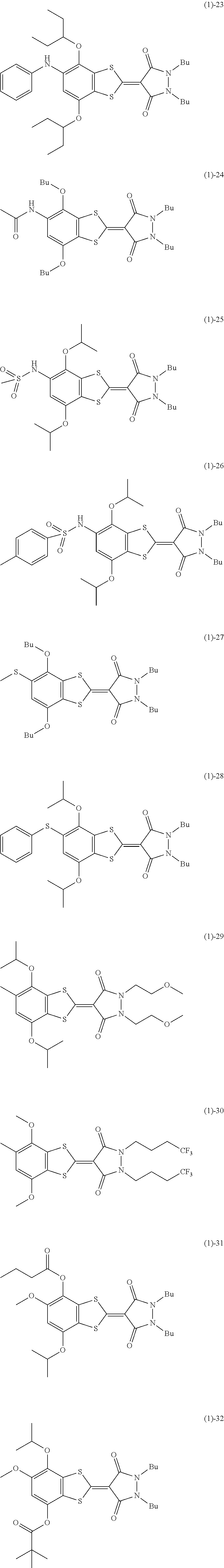

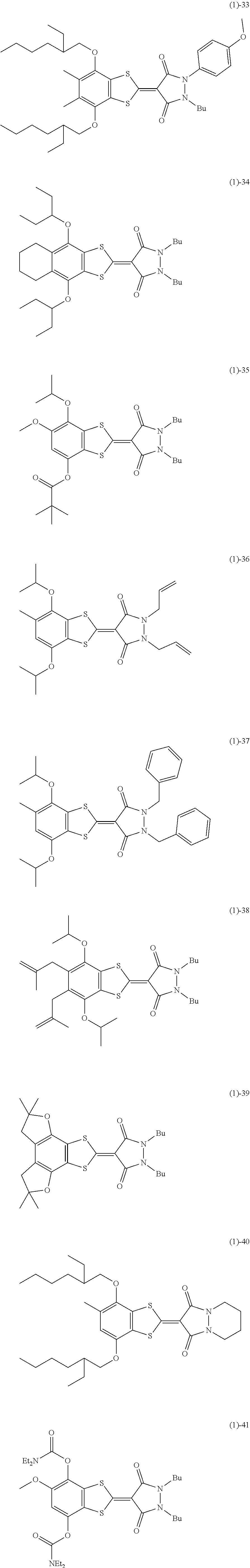

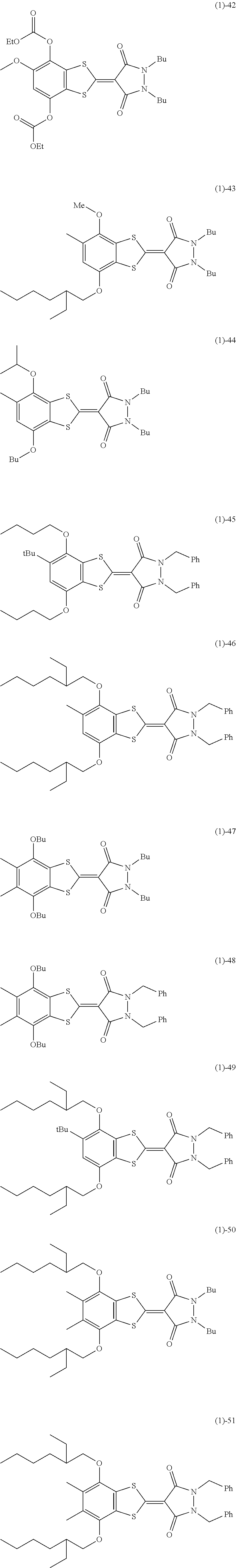

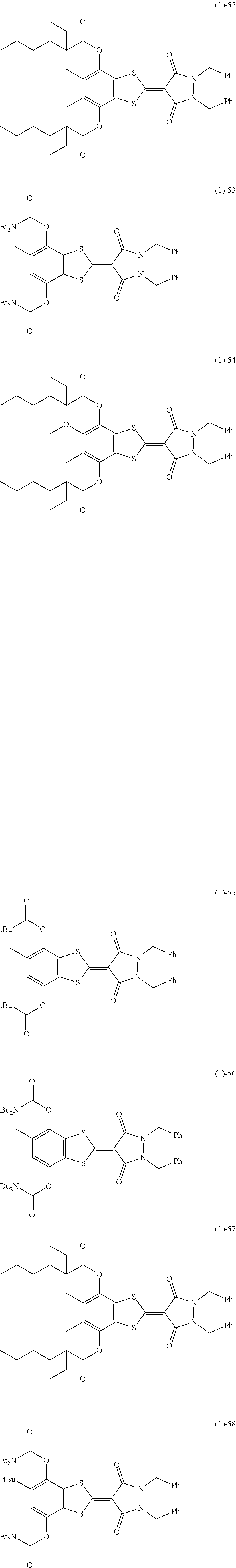

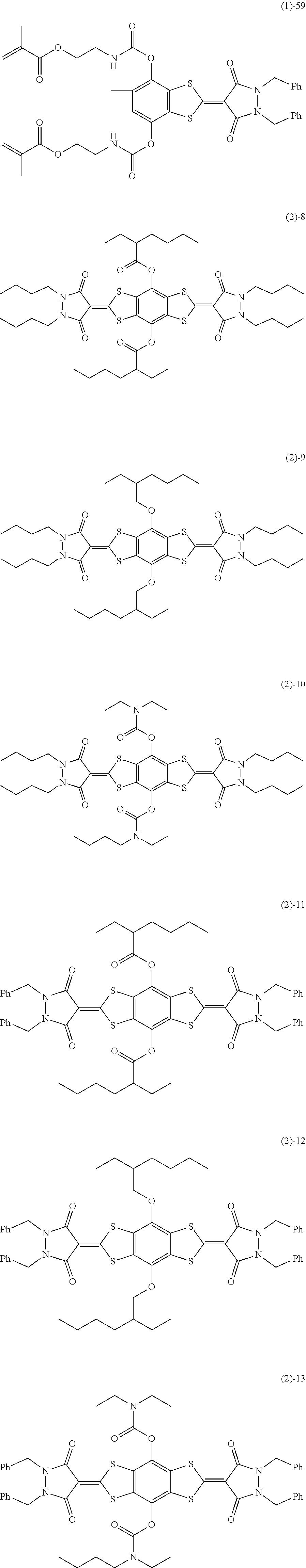

The ultraviolet absorbing agent used in the kneaded material according to the embodiment of the present invention may contain a compound A having a maximal absorption wavelength on a shorter wavelength side than the above-described specific compound.

The maximal absorption wavelength of the compound A is present preferably in a wavelength range of 300 to 380 nm, more preferably in a wavelength range of 300 to 370 nm, still more preferably in a wavelength range of 310 to 360 nm, and particularly preferable in a wavelength range of 310 to 350 nm. According to this aspect, a molded body or the like capable of shielding light having a wavelength in an ultraviolet region over a wide range can be formed.

Further, a difference between the maximal absorption wavelength of the specific compound and the maximal absorption wavelength of the compound A is preferably in a range of 1 to 70 nm, more preferably in a range of 10 to 60 nm, and still more preferably in a range of 20 to 50 nm. According to this aspect, a molded body capable of shielding light having a wavelength in the ultraviolet region over a wide range can be formed.

Examples of the compound A include an aminobutadiene-based compound, a dibenzoylmethane-based compound, a benzotriazole compound, a triazine compound, a benzophenone compound, and an acrylate compound. Among these, from the viewpoint of suppressing precipitation or the like of the ultraviolet absorbing agent from the kneaded material and the molded body by combining the compound A with the specific compound, at least one selected from a benzotriazole compound, a triazine compound, or a benzophenone compound is preferable.

Specific examples of the compound A include compounds having the following structures.

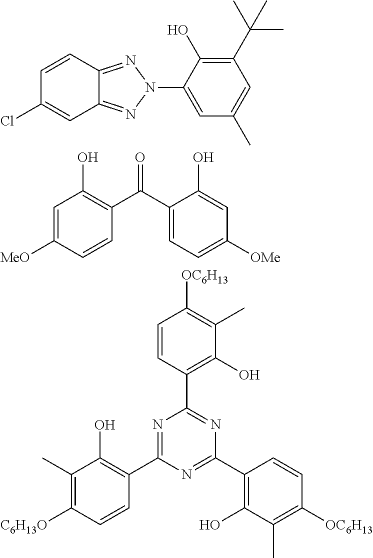

As the compound A, compounds and the like described in JP2003-128730A, JP2003-129033A, JP2014-077076A, JP2015-164994A, JP2015-168822A, JP2018-135282A, JP2018-168089A, JP2018-168278A, JP2018-188589A, JP2019-001767A, JP2020-023697A, JP2020-041013A, JP5518613B, JP5868465B, JP6301526B, JP6354665B, JP2017-503905A, WO2015/064674A, WO2015/064675A, WO2017/102675A, WO2017/122503A, WO2018/190281A, WO2018/216750A, WO2019/087983A, EP2379512B, and EP2951163B can be used.

The content of the ultraviolet absorbing agent is preferably in a range of 0.0005 to 20 parts by mass with respect to 100 parts by mass of the polymer compound. The lower limit thereof is preferably 0.005 parts by mass or greater and more preferably 0.01 parts by mass or greater. The upper limit thereof is preferably 10 parts by mass or less and more preferably 2 parts by mass or less. Further, in a case where the kneaded material according to the embodiment of the present invention is used for master pellet applications, the content of the ultraviolet absorbing agent is preferably in a range of 1 to 50 parts by mass with respect to 100 parts by mass of the polymer compound. The lower limit thereof is preferably 2 parts by mass or greater and more preferably 5 parts by mass or greater. The upper limit thereof is preferably 30 parts by mass or less and more preferably 20 parts by mass or less.

Further, the content of the specific compound is preferably in a range of 0.0005 to 20 parts by mass with respect to 100 parts by mass of the polymer compound. The lower limit thereof is preferably 0.005 parts by mass or greater and more preferably 0.01 parts by mass or greater. The upper limit thereof is preferably 10 parts by mass or less and more preferably 2 parts by mass or less. Further, in a case where the kneaded material according to the embodiment of the present invention is used for master pellet applications, the content of the specific compound is preferably in a range of 1 to 50 parts by mass with respect to 100 parts by mass of the polymer compound. The lower limit thereof is preferably 2 parts by mass or greater and more preferably 5 parts by mass or greater. The upper limit thereof is preferably 30 parts by mass or less and more preferably 20 parts by mass or less. The kneaded material may contain only one or two or more kinds of the specific compounds. In a case where the photopolymerizable composition contains two or more kinds of specific compounds, it is preferable that the total amount thereof is in the above-described ranges.

Further, in a case where the specific compound and the above-described compound A are used in combination as the ultraviolet absorbing agent, the content of the compound A is preferably in a range of 5 to 1,000 parts by mass, more preferably in a range of 10 to 700 parts by mass, and still more preferably in a range of 20 to 500 parts by mass with respect to 100 parts by mass of the specific compound. The kneaded material may contain only one or two or more kinds of the compounds A. In a case where the kneaded material contains two or more kinds of the compounds A, it is preferable that the total amount thereof is in the above-described ranges.

### Polymer Compound

The kneaded material according to the embodiment of the present invention contains a polymer compound. The weight-average molecular weight of the polymer compound is preferably in a range of 3,000 to 2,000,000. The lower limit of the weight-average molecular weight of the polymer compound is preferably 5000 or greater. The upper limit of the weight-average molecular weight of the polymer compound is preferably 1,000,000 or less, more preferably 500,000 or less, and still more preferably 200,000 or less.

The weight-average molecular weight of the polymer compound is a value measured by gel permeation chromatography (GPC). The measurement according to GPC is performed using HLC (registered trademark)-8020GPC (manufactured by Tosoh Corporation) as a measuring device, three columns of TSKgel (registered trademark) Super Multipore HZ-H (manufactured by Tosoh Corporation, 4.6 mmID×15 cm), and tetrahydrofuran (THF) as an eluent. Further, the measurement is performed under measurement conditions of a sample concentration of 0.45% by mass, a flow rate of 0.35 ml/min, a sample injection volume of 10 μl, and a measurement temperature of 40° C. using an RI detector. Further, the calibration curve is prepared using eight samples of “F-40”, “F-20”, “F-4”, “F-1”, “A-5000”, “A-2500”, “A-1000”, and “n-propylbenzene” which are “Standard Samples TSK standard, polystyrene” (manufactured by Tosoh Corporation).

The glass transition point of the polymer compound is preferably −80° C. or higher and 200° C. or lower. The glass transition point of the polymer compound is preferably −30° C. or higher. Further, a glass transition point of the polymer compound is preferably 180° C. or lower. In a case where the glass transition point of the polymer compound is in the above-described ranges, the polymer compound has moderate softness and strength, and has excellent compatibility with the ultraviolet absorbing agent.

The total light transmittance of the polymer compound is preferably 80% or greater, more preferably 85% or greater, and still more preferably 90% or greater. In the present specification, the total light transmittance of the polymer compound is a value measured based on the contents described in “The Fourth Series of Experimental Chemistry 29 Polymer Material” (Maruzen, 1992), pp. 225 to 232, edited by the Chemical Society of Japan.

It is preferable that the polymer compound is a resin. The resin may be a thermoplastic resin or a thermosetting resin. From the viewpoint of the kneadability with the ultraviolet absorbing agent and ease of processing a resin into a molded body, a thermoplastic resin is preferable. Examples of the resin include a (meth)acrylic resin, an ene-thiol resin, a polyester resin, a polycarbonate resin, a vinyl polymer [such as a polydiene resin, a polyalkene resin, a polystyrene resin, a polyvinyl ether resin, a polyvinyl alcohol resin, a polyvinyl ketone resin, a polyfluoro vinyl resin, or a polyvinyl bromide resin], a polythioether resin, a polyphenylene resin, a polyurethane resin, a polysulfonate resin, a nitroso polymer resin, a polysiloxane resin, a polysulfide resin, a polythioester resin, a polysulfone resin, a polysulfonamide resin, a polyamide resin, a polyimine resin, a polyurea resin, a polyphosphazene resin, a polysilane resin, a polysilazane resin, a polyfuran resin, a polybenzoxazole resin, a polyoxadiazole resin, a polybenzothiadinophenothiazine resin, a polybenzothiazole resin, a polypyrazinoquinoxaline resin, polyquinoxaline resin, a polybenzimidazole resin, a polyoxoisoindoline resin, a polydioxoisoindoline resin, a polytriazine resin, a polypyridazine resin, a polypiperazine resin, a polypyridine resin, a polypiperidine resin, a polytriazole resin, a polypyrazole resin, a polypyrrolidine resin, a polycarborane resin, a polyoxabicyclononane resin, a polydibenzofuran resin, a polyphthalide resin, a polyacetal resin, a polyimide resin, a polyamide imide resin, an olefin resin, a cyclic olefin resin, an epoxy resin, and a cellulose acylate resin. Among these, from the viewpoint of satisfactory kneadability with the above-described specific compound and easily forming a kneaded material in which precipitation or the like of the ultraviolet absorbing agent is suppressed, at least one selected from a (meth)acrylic resin, a polystyrene resin, a polyester resin, a polyurethane resin, a polythiourethane resin, a polyamide resin, a polyimide resin, a cyclic olefin resin, an epoxy resin, a polycarbonate resin, a vinyl polymer, or a cellulose acylate resin is preferable, at least one selected from a polycarbonate resin, a polyester resin, a (meth)acrylic resin, a polyurethane resin, a polyamide resin, a cyclic olefin resin, or a vinyl polymer is more preferable, and at least one selected from a polycarbonate resin, a polyester resin, a (meth)acrylic resin, a polyurethane resin, or a vinyl polymer is still more preferable.

Examples of the (meth)acrylic resin include a polymer having a constitutional unit derived from (meth)acrylic acid and/or an ester thereof. Specific examples thereof include a polymer obtained by carrying out a polymerization reaction on at least one compound selected from the group consisting of (meth)acrylic acid, (meth)acrylic acid ester, (meth)acrylamide, and (meth)acrylonitrile.

Examples of the polyester resin include a polymer obtained by a reaction between a polyol (such as ethylene glycol, propylene glycol, glycerin, or trimethylolpropane) and a polybasic acid (for example, an aromatic dicarboxylic acid (such as terephthalic acid, isophthalic acid, naphthalenedicarboxylic acid, or a dicarboxylic acid in which a hydrogen atom of any of these aromatic rings is substituted with a methyl group, an ethyl group, a phenyl group, or the like), an aliphatic dicarboxylic acid having 2 to 20 carbon atoms (such as adipic acid, sebacic acid, or decanedicarboxylic acid), or an alicyclic dicarboxylic acid (such as cyclohexanedicarboxylic acid)), and a polymer (such as polycaprolactone) obtained by ring-opening polymerization of a cyclic ester compound such as a caprolactone monomer. Specific examples of the polyester resin include polyethylene terephthalate and polyethylene naphthalate.

Examples of the epoxy resin include a bisphenol A type epoxy resin, a bisphenol F type epoxy resin, a phenol novolak type epoxy resin, a cresol novolak type epoxy resin, and an aliphatic epoxy resin. As the epoxy resin, a commercially available product may be used, and examples of the commercially available product include the following products.

Examples of a commercially available product of the bisphenol A type epoxy resins include jER825, jER827, jER828, jER834, jER1001, jER1002, jER1003, jER1055, jER1007, jER1009, and jER1010 (all manufactured by Mitsubishi Chemical Corporation), and EPICLON860, EPICLON1050, EPICLON1051, and EPICLON1055 (all manufactured by DIC Corporation). Examples of a commercially available product of the bisphenol F type epoxy resins include jER806, jER807, jER4004, jER4005, jER4007, and jER4010 (all manufactured by Mitsubishi Chemical Corporation), EPICLON830 and EPICLON835 (both manufactured by DIC Corporation), and LCE-21 and RE-6025 (both manufactured by Nippon Kayaku Co., Ltd.). Examples of a commercially available product of the phenol novolak type epoxy resins include jER152, jER154, jER157S70, and jER157S65 (all manufactured by Mitsubishi Chemical Corporation), and EPICLON N-740, EPICLON N-770, and EPICLON N-775 (all manufactured by DIC Corporation). Examples of the commercially available product of the cresol novolak type epoxy resins include EPICLON N-660, EPICLON N-665, EPICLON N-670, EPICLON N-673, EPICLON N-680, EPICLON N-690, and EPICLON N-695 (all manufactured by DIC Corporation), and EOCN-1020 (manufactured by Nippon Kayaku Co., Ltd.). Examples of the commercially available product of the aliphatic epoxy resin include ADEKA RESIN EP Series (such as EP-4080S, EP-4085S, and EP-4088S; manufactured by ADEKA Corporation), CELLOXIDE 2021P, CELLOXIDE 2081, CELLOXIDE 2083, CELLOXIDE 2085, EHPE3150, EPOLEAD PB 3600, and EPOLEAD PB 4700 (all manufactured by Daicel Corporation), DENACOL EX-212L, EX-214L, EX-216L, EX-321L, and EX-850L (all manufactured by Nagase ChemteX Corporation), ADEKA RESIN EP Series (such as EP-4000S, EP-4003S, EP-4010S, and EP-4011S; manufactured by ADEKA Corporation), NC-2000, NC-3000, NC-7300, XD-1000, EPPN-501, and EPPN-502 (all manufactured by ADEKA Corporation), and jER1031S (manufactured by Mitsubishi Chemical Corporation). Further, examples of a commercially available product of the epoxy resins include MARPROOF G-0150M, G-0105SA, G-0130SP, G-0250SP, G-1005S, G-1005SA, G-1010S, G-2050M, G-01100, and G-01758 (all manufactured by NOF Corporation, epoxy group-containing polymer).

As the cellulose acylate resin, the cellulose acylate described in paragraphs 0016 to 0021 of JP2012-215689A is preferably used. As the polyester resin, a commercially available product such as the VYLON Series (for example, VYLON 500, manufactured by Toyobo Co., Ltd.) can also be used. As a commercially available product of the (meth)acrylic resin, SK Dyne Series (for example, SK Dyne-SF2147, manufactured by Soken Chemical & Engineering Co., Ltd.) can also be used.

As the polystyrene resin, a resin having 50% by mass or greater of a repeating unit derived from a styrene-based monomer is preferable, a resin having 70% by mass or greater of a repeating unit derived from a styrene-based monomer is more preferable, and a resin having 85% by mass or greater of a repeating unit derived from a styrene-based monomer is still more preferable.

Specific examples of the styrene-based monomer include styrene and a derivative thereof. Here, the styrene derivative is a compound in which another group is bonded to styrene, and examples thereof include alkylstyrene such as o-methylstyrene, m-methylstyrene, p-methylstyrene, 2,4-dimethylstyrene, o-ethylstyrene, or p-ethylstyrene, and substituted styrene in which a hydroxy group, an alkoxy group, a carboxyl group, or halogen is introduced to a benzene nucleus of styrene such as hydroxystyrene, tert-butoxystyrene, vinyl benzoic acid, o-chlorostyrene, or p-chlorostyrene.

In addition, the polystyrene resin may have a repeating unit derived from a monomer other than the styrene-based monomer. Examples of other monomers include alkyl (meth)acrylate such as methyl (meth)acrylate, cyclohexyl (meth)acrylate, methylphenyl (meth)acrylate, or isopropyl (meth)acrylate; an unsaturated carboxylic acid monomer such as methacrylic acid, acrylic acid, itaconic acid, maleic acid, fumaric acid, or cinnamic acid; an unsaturated dicarboxylic acid anhydride monomer which is an anhydride of maleic acid, itaconic acid, ethylmaleic acid, methylitaconic acid, or chloromaleic acid; an unsaturated nitrile monomer such as acrylonitrile or methacrylonitrile; and a conjugated diene such as 1,3-butadiene, 2-methyl-1,3-butadiene (isoprene), 2,3-dimethyl-1,3-butadiene, 1,3-pentadiene, or 1,3-hexadiene.

Examples of a commercially available product of the polystyrene resin include AS-70 (acrylonitrile/styrene copolymer resin, manufactured by NIPPON STEEL Chemical & Material Co., Ltd.) and SMA2000P (styrene/maleic acid copolymer, manufactured by Kawahara Petrochemical Co., Ltd.).

Examples of the polycarbonate resin include reactants of polyhydric phenols with phosgene or carbonic acid esters.

Examples of the polyhydric phenols include hydroquinone, resorcinol, 4,4′-dihydroxydiphenyl, bis(4-hydroxyphenyl)methane, 1,1-bis(4-hydroxyphenyl)ethane, 1,1-bis(4-hydroxyphenyl)-1-phenylethane, bisphenol A, bisphenol C, bisphenol E, bisphenol F, bisphenol M, bisphenol P, bisphenol S, bisphenol Z, 2,2-bis(3-methyl-4-hydroxyphenyl)propane, 1,1-bis(4-hydroxyphenyl)cyclohexane, 2,2-bis(3-phenyl-4-hydroxyphenyl)propane, 2,2-bis(3-isopropyl-4-hydroxyphenyl)propane, 2,2-bis(4-hydroxyphenyl)butane, 2,2-bis(3,5-dimethyl-4-hydroxyphenyl)propane, 2,2-bis(3,5-dibromo-4-hydroxyphenyl)propane, 4,4′-dihydroxydiphenyl sulfone, 4,4′-dihydroxydiphenyl sulfoxide, 4,4′-dihydroxydiphenyl sulfide, 3,3′-dimethyl-4,4′-dihydroxydiphenyl sulfide, and 4,4′-dihydroxydiphenyl oxide. Among these, hydroquinone, resorcinol, 4,4′-dihydroxydiphenyl, or bisphenol A is preferable.

Examples of the carbonic acid esters include bisalkyl carbonate and bisaryl carbonate. Specific examples thereof include diphenyl carbonate, bis(chlorophenyl) carbonate, dinaphthyl carbonate, bis(diphenyl) carbonate, dimethyl carbonate, diethyl carbonate, and dibutyl carbonate. Among these, bis(diphenyl) carbonate, dimethyl carbonate, or diethyl carbonate is preferable.

Examples of a commercially available product of the polycarbonate resin include SD POLYCA Series (manufactured by Sumika Polycarbonate Limited).

Examples of the thiourethane resin include a reactant of an isocyanate compound and a polythiol compound and a reactant of a thiourethane resin precursor. Examples of a commercially available product of the thiourethane resin precursor include MR-7, MR-8, MR-10, and MR-174 (manufactured by Mitsui Chemicals, Inc.).

Examples of the polyamide resin include an aliphatic polyamide resin and an aromatic polyamide resin. Examples of the aliphatic polyamide resin include Nylon 6, Nylon 11, Nylon 12, Nylon 46, Nylon 66, Nylon 666, Nylon 610, and Nylon 612. Examples of the aromatic polyamide resin include a resin which is polymerized by dehydration condensation of a diamine and a dicarboxylic acid and for which at least one of a diamine or a dicarboxylic acid having an aromatic ring is used. Specific examples of the aromatic polyamide resin include a condensation polymer of m-xylylenediamine and adipic acid or an adipic acid halide.

Examples of the cyclic olefin resin include (1) a polymer having a structural unit derived from a norbornene compound, (2) a polymer having a structural unit derived from a monocyclic olefin compound other than a norbornene compound, (3) a polymer having a structural unit derived from a cyclic conjugated diene compound, (4) a polymer having a structural unit derived from a vinyl alicyclic hydrocarbon compound, and a hydride of a polymer having a structural unit derived from each of the compounds in the items (1) to (4). In the present specification, the polymer having a structural unit derived from a norbornene compound and the polymer having a structural unit derived from a monocyclic olefin compound contains ring-opening polymers of the respective compounds.

Addition (co)polymers of a norbornene compound are described in JP1998-007732A (JP-H10-007732A), JP2002-504184A, US2004/229157A1, WO2004/070463A, and the like. The polymer of a norbornene compound is obtained by an addition polymerization of norbornene compounds (for example, polycyclic unsaturated compounds of norbornene).

The hydride of a polymer of a norbornene compound can be synthesized by the addition polymerization or the metathesis ring-opening polymerization of a norbornene compound or the like and then the addition of hydrogen. The synthesis method is described, for example, in JP1989-240517A (JP-H01-240517A), JP1995-196736A (JP-H07-196736A), JP1985-026024A (JP-S60-026024A), JP1987-019801A (JP-S62-019801A), JP2003-159767A, and JP2004-309979A.

Examples of a commercially available product of the cyclic olefin resin include ARTON series (for example, ARTON G, ARTON F, and ARTON RX4500, manufactured by JSR Corporation), and ZEONOR ZF14, ZF16, ZEONEX 250, and ZEONEX 280 (manufactured by Zeon Corporation).

The resin may be an alkali-soluble resin. Examples of the alkali-soluble resin include resins having an acid group. Examples of the acid group include a carboxyl group, a phosphoric acid group, a sulfonic acid group, and a phenolic hydroxy group. The acid group may be used alone or in combination of two or more kinds thereof.

As the alkali-soluble resin, an alkali-soluble resin that is soluble in an organic solvent and can be developed with a weak alkaline aqueous solution is preferable. Examples of such an alkali-soluble resin include polymers containing a carboxyl group in a side chain, for example, acidic cellulose derivatives containing a carboxyl group in a side chain such as a methacrylic acid copolymer, an acrylic acid copolymer, an itaconic acid copolymer, a crotonic acid copolymer, a maleic acid copolymer, and a partially esterified maleic acid copolymer, as described in JP1984-044615A (JP-S59-044615A), JP1979-034327A (JP- S54-034327A), JP-1983-012577A (JP-S58-012577A), JP1979-025957A (JP-S54-025957A), JP1984-053836A (JP-S59-053836A), and JP1984-071048A (JP-S59-071048A).

Further, as the alkali-soluble resin, a resin obtained by adding an acid anhydride to a polymer containing a hydroxy group is also useful.

The alkali-soluble resin may be a resin obtained by copolymerizing a monomer having hydrophilicity. Examples of the monomer having hydrophilicity include alkoxyalkyl (meth)acrylate, hydroxyalkyl (meth)acrylate, glycerol (meth)acrylate, (meth)acrylamide, N-methylolacrylamide, secondary or tertiary alkylacrylamide, dialkylaminoalkyl (meth)acrylate, morpholine (meth)acrylate, N-vinylpyrrolidone, N-vinylcaprolactam, vinylimidazole, vinyl triazole, methyl (meth)acrylate, ethyl (meth)acrylate, branched or linear propyl (meth)acrylate, branched or linear butyl (meth)acrylate, and phenoxyhydroxypropyl (meth)acrylate. Further, as the monomer having hydrophilicity, monomers containing a tetrahydrofurfuryl group, a phosphoric acid group, a phosphoric acid ester group, a quaternary ammonium base, an ethyleneoxy chain, a propyleneoxy chain, a sulfonic acid group, and groups derived from salts thereof, and a morpholinoethyl group are also useful.

In order to improve crosslinking efficiency, the alkali-soluble resin may contain an ethylenically unsaturated bond-containing group such as a vinyl group, a styrene group, an allyl group, a methallyl group, or a (meth)acryloyl group. Examples of a commercially available product of the alkali-soluble resin containing an ethylenically unsaturated bond-containing group include DIANAL BR Series (polymethyl methacrylate (PMMA), for example, DIANAL BR-80, BR-83, and BR-87; manufactured by Mitsubishi Chemical Corporation), Photomer 6173 (carboxyl group-containing polyurethane acrylic oligomer, manufactured by Diamond Shamrock Co., Ltd.), VISCOAT R-264 and KS Resist 106 (both manufactured by Osaka Organic Chemical Industry Ltd.), CYCLOMER P Series (for example, ACA230AA) and PLACCEL CF200 Series (all manufactured by Daicel Corporation), Ebecryl 3800 (manufactured by Daicel UCB Co.), and ACRYCURE-RD-F8 (manufactured by Nippon Shokubai Co., Ltd.).

Among these various alkali-soluble resins, a polyhydroxystyrene resin, a (meth)acrylic resin, a polystyrene resin, and a polysiloxane resin are preferable from the viewpoint of the heat resistance, and a (meth)acrylic resin is more preferable from the viewpoint of controlling the developability.

The weight-average molecular weight of the alkali-soluble resin is preferably in a range of 3,000 to 200,000 and more preferably in a range of 5,000 to 50,000.

The acid value of the alkali-soluble resin is preferably in a range of 30 to 200 mgKOH/g. The lower limit of the acid value thereof is preferably 50 mgKOH/g or greater and more preferably 70 mgKOH/g or greater. Further, the upper limit of the acid value is preferably 150 mgKOH/g or less and more preferably 120 mgKOH/g or less. The acid value of the resin is a value calculated by performing measurement in conformity with JIS K 0070 (1992) and converting the measured value in terms of 1 mmol/g=56.1 mgKOH/g.

In regard to the alkali-soluble resin, the description in paragraphs 0558 to 0571 of JP2012-208494A (paragraphs. 0685 to 0700 of the corresponding US2012/0235099A) and the description in paragraphs 0076 to 0099 of JP2012-198408A can be referred to, and the contents of which are incorporated herein by reference.

The content of the polymer compound in the kneaded material is preferably 50% by mass or greater, more preferably 70% by mass or greater, and still more preferably 80% by mass or greater. The upper limit thereof can be set to, for example, 99% by mass or less. The kneaded material may contain only one or two or more kinds of the polymer compounds. In a case where the kneaded material contains two or more kinds of the polymer compounds, it is preferable that the total amount thereof is in the above-described ranges.

### Plasticizer

The kneaded material according to the embodiment of the present invention can contain a plasticizer. In a case where the kneaded material contains a plasticizer, an effect of adjusting the physical properties of the polymer compound, controlling the compatibility, and improving the stability (particularly, light fastness) can be obtained. Examples of the plasticizer include a phthalic acid ester-based plasticizer, a phosphoric acid ester-based plasticizer, a trimellitic acid ester-based plasticizer, a fatty acid ester-based plasticizer, a polyester-based plasticizer, a glycerin-based plasticizer, and a polyalkylene glycol-based plasticizer. From the viewpoint of the compatibility with the polymer compound, a phthalic acid ester-based plasticizer or a phosphoric acid ester-based plasticizer is preferable.

Examples of the phthalic acid ester-based plasticizer include dimethyl phthalate, diethyl phthalate, diisopropyl phthalate, dibutyl phthalate, diisobutyl phthalate, dihexyl phthalate, dicyclohexyl phthalate, diphenyl phthalate, bis(2-ethylhexyl) phthalate, diisononyl phthalate, diisodecyl phthalate, and diundecyl phthalate.

Examples of the phosphoric acid ester-based plasticizer include trimethyl phosphate, triethyl phosphate, tributyl phosphate, triphenyl phosphate, and tricresyl phosphate.

Examples of the trimellitic acid ester-based plasticizer include tributyl trimellitate and tris(2-ethylhexyl) trimellitate.

Examples of the fatty acid ester-based plasticizer include dimethyl adipate, diethyl adipate, dipropyl adipate, diisopropyl adipate, dibutyl adipate, diisobutyl adipate, dimethyl dodecanoate, dibutyl maleate, and ethyl oleate.

Examples of the polyester-based plasticizer include polyester consisting of an acid component such as adipic acid, sebacic acid, terephthalic acid, isophthalic acid, naphthalenedicarboxylic acid, diphenyldicarboxylic acid, or rosin and a diol component such as propylene glycol, 1,3-butanediol, 1,4-butanediol, 1,6-hexanediol, ethylene glycol, or diethylene glycol, and polyester consisting of hydroxycarboxylic acid such as polycaprolactone. The terminals of these polyesters may be blocked with a monofunctional carboxylic acid or a monofunctional alcohol, or the terminals thereof may be blocked with an epoxy compound or the like.

Examples of the glycerin-based plasticizer include glycerin monoacetomonolaurate, glycerin diacetomonolaurate, glycerin monoacetomonostearate, glycerin diacetomonooleate, and glycerin monoacetomonomontanate.

Examples of the polyalkylene glycol-based plasticizer include polyalkylene glycol such as polyethylene glycol, polypropylene glycol, polytetramethylene glycol, an ethylene oxide addition polymer of bisphenols, a propylene oxide addition polymer of bisphenols, or a tetrahydrofuran addition polymer of bisphenols, and a terminal epoxy-modified compound, a terminal ester-modified compound, and a terminal ether-modified compound thereof.

The molecular weight of the plasticizer is preferably less than 3,000, more preferably 2,000 or less, and still more preferably 1,500 or less.

The content of the plasticizer in the kneaded material is preferably in a range of 0.001% to 30% by mass. The lower limit thereof is preferably 0.005% by mass or greater and more preferably 0.01% by mass or greater. The upper limit of the content of the epoxy compound is preferably 20% by mass or less and more preferably 10% by mass or less.

Further, the content of the plasticizer in the kneaded material is preferably in a range of 0.001 to 30 parts by mass with respect to 100 parts by mass of the polymer compound. The lower limit thereof is preferably 0.005 parts by mass or greater and more preferably 0.01 parts by mass or greater. The upper limit thereof is preferably 20 parts by mass or less and more preferably 10 parts by mass or less.

The kneaded material may contain only one or two or more kinds of the plasticizers. In a case where the kneaded material contains two or more kinds of the plasticizers, it is preferable that the total amount thereof is in the above-described ranges.

### Polymerizable Monomer

The kneaded material according to the embodiment of the present invention can contain a polymerizable monomer. The polymerizable monomer is preferably a compound containing an ethylenically unsaturated bond-containing group and more preferably a compound containing two or more ethylenically unsaturated bond-containing groups. The upper limit of the number of ethylenically unsaturated bond-containing groups contained in the polymerizable monomer is preferably 15 or less, more preferably 10 or less, and still more preferably 6 or less. Examples of the ethylenically unsaturated bond-containing group contained in the polymerizable compound include a vinyl group, an allyl group, and a (meth)acryloyl group.

The molecular weight of the polymerizable monomer is preferably 100 to 2,000. The upper limit is preferably 1,500 or less and more preferably 1,000 or less. The lower limit is more preferably 150 or greater and still more preferably 250 or greater.

As the polymerizable monomer, a (meth)acrylate compound is preferable, a bifunctional or higher functional (meth)acrylate compound is more preferable, a bifunctional to pentadecafunctional (meth)acrylate compound is still more preferable, a bifunctional to decafunctional (meth)acrylate compound is even still more preferable, and a bifunctional to hexafunctional (meth)acrylate compound is particularly preferable.

Specific examples of the polymerizable monomer include pentaerythritol tri(meth)acrylate, pentaerythritol tetra(meth)acrylate, dipentaerythritol penta(meth)acrylate, dipentaerythritol hexa(meth)acrylate, tri((meth)acryloyloxyethyl) isocyanurate, a pentaerythritol tetra(meth)acrylate ethylene oxide (EO)-modified product, a dipentaerythritol hexa(meth)acrylate ethylene oxide (EO)-modified product, and benzyl (meth)acrylate.

Examples of a commercially available product of the polymerizable monomer include polyfunctional (meth)acrylate compounds such as KAYARAD Series (for example, D-330, D-320, D-310, PET-30, TPA-330, and DPHA, manufactured by Nippon Kayaku Co., Ltd.), NK Ester Series (for example, A-DPH-12E, A-TMMT, and A-TMM-3, manufactured by Shin-Nakamura Chemical Co., Ltd.), Light Acrylate Series (for example, DCP-A, manufactured by Kyoeisha Chemical Co., Ltd.), ARONIX Series (for example, M-305, M-306, M-309, M-450, M-402, and TO-1382, manufactured by Toagosei Company, Limited), and VISCOAT Series (for example, V#802, manufactured by Osaka Organic Chemical Industry Ltd.).

As the polymerizable monomer, the (meth)acrylate compounds described in JP1973-064183A (JP-548-064183A), JP1974-043191B (JP-549-043191B), and JP1977-030490B (JP-552-030490B), and the compounds introduced as photocurable monomers and oligomers in The Adhesion Society of Japan, vol. 20, No. 7, pp. 300 to 308 (1984) can be used.

The content of the polymerizable monomer in the kneaded material is preferably in a range of 1% to 20% by mass. The lower limit thereof is preferably 2% by mass or greater. The upper limit thereof is preferably 10% by mass or less. The kneaded material may contain only one or two or more kinds of polymerizable monomers. In a case where the kneaded material contains two or more kinds of polymerizable monomers, it is preferable that the total amount thereof is in the above-described ranges.

### Polymerization Initiator

The kneaded material according to the embodiment of the present invention may contain a polymerization initiator. As the polymerization initiator, a compound capable of generating an initiating species required for the polymerization reaction by applying energy can be used. The polymerization initiator can be appropriately selected from, for example, a photopolymerization initiator and a thermal polymerization initiator.

Examples of the photopolymerization initiator include a halogenated hydrocarbon derivative (such as a compound having a triazine skeleton or a compound having an oxadiazole skeleton), an acylphosphine compound, hexaarylbiimidazole, an oxime compound, an organic peroxide, a thio compound, a ketone compound, an aromatic onium salt, an aminoacetophenone compound, and a hydroxyacetophenone compound. Examples of the aminoacetophenone compound include aminoacetophenone-based initiators described in JP2009-191179A and JP1998-291969A (JP-H10-291969A). Examples of the acylphosphine compound include the acylphosphine-based initiator described in JP4225898B. As the photopolymerization initiator, a synthetic product or a commercially available product may be used.

Examples of commercially available products of the hydroxyacetophenone compound include Omnirad 184, Omnirad 1173, Omnirad 2959, and Omnirad 127 (all manufactured by IGM Resins B. V.). Examples of commercially available products of the aminoacetophenone compound include Omnirad 907, Omnirad 369, Omnirad 369E, and Omnirad 379EG (all manufactured by IGM Resins B. V.). Examples of commercially available products of the acylphosphine compound include Omnirad 819 and Omnirad TPO (both manufactured by IGM Resins B. V.).

As the photopolymerization initiator, an oxime compound is preferable. Specific examples of the oxime compound include the compounds described in JP2001-233842A, the compounds described in JP2000-080068A, the compounds described in JP2006-342166A, and the compounds described in paragraphs 0073 to 0075 of JP2016-006475A. Among the examples of the oxime compound, an oxime ester compound is preferable. Examples of commercially available products of the oxime compound include Irgacure OXE01, Irgacure OXE02 (manufactured by BASF SE), and Irgacure OXE03 (manufactured by BASF SE).

Examples of the thermal polymerization initiator include an aromatic ketone compound, an onium salt compound, an organic peroxide, a thio compound, a hexaarylbiimidazole compound, a ketoxime ester compound, a borate compound, an azinium compound, a metallocene compound, an active ester compound, a compound having a carbon halogen bond, and an azo-based compound. Specific examples of the thermal polymerization initiator include the compounds described in paragraphs 0074 to 0118 of JP2008-063554A.

The content of the polymerization initiator in the kneaded material is preferably in a range of 0.01 to 100 parts by mass with respect to 100 parts by mass of the polymerizable monomer. The lower limit thereof is preferably 0.05 part by mass or greater. The upper limit thereof is preferably 10 parts by mass or less. The kneaded material may contain only one or two or more kinds of polymerization initiators. In a case where the polymerization composition contains two or more kinds of polymerization initiators, it is preferable that the total amount thereof is in the above-described range.

### Silane Coupling Agent

The kneaded material according to the embodiment of the present invention may contain a silane coupling agent. In the present invention, the silane coupling agent denotes a silane compound containing a hydrolyzable group and other functional groups. Further, the hydrolyzable group denotes a substituent that is directly bonded to a silicon atom and can form a siloxane bond by at least one of a hydrolysis reaction or a condensation reaction. Examples of the hydrolyzable group include a halogen atom, an alkoxy group, and an acyloxy group. Among these, an alkoxy group is preferable. That is, it is preferable that the silane coupling agent is a compound containing an alkoxysilyl group. Examples of the functional group other than the hydrolyzable group include a vinyl group, a (meth)allyl group, a (meth)acryloyl group, a mercapto group, an epoxy group, an oxetanyl group, an amino group, a ureido group, a sulfide group, and an isocyanate group, and a phenyl group. Among these, an amino group, a (meth)acryloyl group, and an epoxy group are preferable. Specific examples of the silane coupling agent include the compounds described in paragraphs 0018 to 0036 of JP2009-288703A and the compounds described in paragraphs 0056 to 0066 of JP2009-242604A, and the contents thereof are incorporated in the present specification. Examples of commercially available products of the silane coupling agent include A-50 (organosilane) (manufactured by Soken Chemical & Engineering Co., Ltd.).

The content of the silane coupling agent in the kneaded material is preferably in a range of 0.1% to 5% by mass. The upper limit thereof is preferably 3% by mass or less and more preferably 2% by mass or less. The lower limit thereof is preferably 0.5% by mass or greater and more preferably 1% by mass or greater. The kneaded material may contain only one or two or more kinds of silane coupling agents. In a case where the polymerizable composition contains two or more kinds of silane coupling agents, it is preferable that the total amount thereof is in the above-described range.

### Surfactant

The kneaded material according to the embodiment of the present invention can contain a surfactant. Examples of the surfactant include the surfactants described in paragraph 0017 of JP4502784B and paragraphs 0060 to 0071 of JP2009-237362A.

As the surfactant, a nonionic surfactant, a fluorine-based surfactant, or a silicone-based surfactant is preferable.

Examples of commercially available products of the fluorine-based surfactant include MEGAFACE F-171, F-172, F-173, F-176, F-177, F-141, F-142, F-143, F-144, F-437, F-475, F-477, F-479, F-482, F-551-A, F-552, F-554, F-555-A, F-556, F-557, F-558, F-559, F-560, F-561, F-565, F-563, F-568, F-575, F-780, EXP, MFS-330, R-41, R-41-LM, R-01, R-40, R-40-LM, RS-43, TF-1956, RS-90, R-94, RS-72-K, and DS-21 (all manufactured by DIC Corporation), FLUORARD FC430, FC431, and FC171 (all manufactured by Sumitomo 3M Ltd.), SURFLON S-382, SC-101, SC-103, SC-104, SC-105, SC-1068, SC-381, SC-383, S-393, and KH-40 (all manufactured by AGC Inc.), PolyFox PF636, PF656, PF6320, PF6520, and PF7002 (all manufactured by OMNOVA Solutions Inc.), and FTERGENT 710FM, 610FM, 601AD, 601ADH2, 602A, 215M, 245F, 251, 212M, 250, 209F, 222F, 208G, 710LA, 710FS, 730LM, 650AC, and 681 (all manufactured by NEOS Company Limited).

The fluorine-based surfactant has a molecular structure containing a functional group having a fluorine atom, and an acrylic compound in which a portion of the functional group having a fluorine atom is cleaved in a case where heat is applied thereto so that the fluorine atom volatilizes can also be suitably used. Examples of the fluorine-based surfactant include MEGAFACE DS Series (manufactured by DIC Corporation (The Chemical Daily (Feb. 22, 2016) and Nikkei Sangyo Daily (Feb. 23, 2016)) such as MEGAFACE DS-21.

A polymer of a fluorine atom-containing vinyl ether compound containing a fluorinated alkyl group or a fluorinated alkylene ether group and a hydrophilic vinyl ether compound is also preferably used as the fluorine-based surfactant.

A block polymer can also be used as the fluorine-based surfactant.

A fluorine-containing polymer compound having a repeating unit derived from a (meth)acrylate compound having a fluorine atom and a repeating unit derived from a (meth)acrylate compound containing 2 or more (preferably 5 or more) alkyleneoxy groups (preferably ethyleneoxy groups or propyleneoxy groups) can also be used as the fluorine-based surfactant.

A fluorine-containing polymer containing an ethylenically unsaturated bond-containing group in a side chain can also be used as the fluorine-based surfactant. Examples of commercially available products thereof include MEGAFACE RS-101, RS-102, RS-718K, and RS-72-K (all manufactured by DIC Corporation).

Due to concerns of the environmental suitability in a case of a compound containing a linear perfluoroalkyl group having 7 or more carbon atoms, an alternative material for perfluorooctanoic acid (PFOA) or perfluorooctanesulfonic acid (PFOS) is preferably used as the fluorine-based surfactant.

Examples of the silicone-based surfactant include a linear polymer consisting of a siloxane bond and a modified siloxane polymer in which an organic group is introduced into a side chain or a terminal. Examples of commercially available products of the silicone-based surfactant include DOWSIL 8032 ADDITIVE, Toray Silicone DC3PA, Toray Silicone SH7PA, Toray Silicone DC11PA, Toray Silicone SH21PA, Toray Silicone SH28PA, Toray Silicone SH29PA, Toray Silicone SH30PA, and Toray Silicone SH8400 (all manufactured by Dow Toray Co., Ltd.), X-22-4952, X-22-4272, X-22-6266, KF-351A, K354L, KF-355A, KF-945, KF-640, KF-642, KF-643, X-22-6191, X-22-4515, KF-6004, KP-341, KF-6001, and KF-6002 (all manufactured by Shin-Etsu Chemical Co., Ltd.), F-4440, TSF-4300, TSF-4445, TSF-4460, and TSF-4452 (all manufactured by Momentive Performance Materials Inc.), and BYK-307, BYK-323, and BYK-330 (all manufactured by BYK-Chemie GmbH).

Examples of the nonionic surfactant include glycerol, trimethylolpropane, trimethylolethane, ethoxylate and propoxylate thereof (such as glycerol propoxylate or glycerol ethoxylate), polyoxyethylene lauryl ether, polyoxyethylene stearyl ether, polyoxyethylene oleyl ether, polyoxyethylene octyl phenyl ether, polyoxyethylene nonyl phenyl ether, polyethylene glycol dilaurate, polyethylene glycol distearate, and sorbitan fatty acid ester. Examples of commercially available products of the nonionic surfactant include PLURONIC L10, L31, L61, L62, 10R5, 17R2, and 25R2 (all manufactured by BASF SE), TETRONIC 304, 701, 704, 901, 904, and 150R1 (all manufactured by BASF SE), SOLSPERSE 20000 (manufactured by The Lubrizol Corporation), NCW-101, NCW-1001, and NCW-1002 (all manufactured by FUJIFILM Wako Pure Chemical Corporation), PIONIN D-6112, D-6112-W, and D-6315 (all manufactured by Takemoto Oil & Fat Co., Ltd.), and OLFINE E1010, SURFINOL 104, 400, and 440 (all manufactured by Nisshin Chemical Co., Ltd.).

The content of the surfactant in the kneaded material is preferably in a range of 0.001% by mass to 5.0% by mass and more preferably in a range of 0.005 to 3.0% by mass. The kneaded material may contain only one or two or more kinds of surfactants. In a case where the polymerizable composition contains two or more kinds of surfactants, it is preferable that the total amount thereof is in the above-described ranges.

### Organic Solvent

The kneaded material according to the embodiment of the present invention may contain an organic solvent. Examples of the organic solvent include an alcohol-based solvent, an ester-based solvent, a ketone-based solvent, an amide-based solvent, an ether-based solvent, a hydrocarbon-based solvent, and a halogen-based solvent. Specific examples of the organic solvent include methanol, ethanol, 1-propanol, 2-propanol, 1-butanol, 2-butanol, 2-methyl-1-propanol, 1-methoxy-2-propanol, 2-ethoxyethanol, 2-butoxyethanol, polyethylene glycol monoalkyl ether, polypropylene glycol monoalkyl ether, ethylene glycol, propylene glycol, polyethylene glycol, polypropylene glycol, glycerin, ethylene carbonate, N-methylpyrrolidone, dioxane, tetrahydrofuran, ethylene glycol dialkyl ether, propylene glycol dialkyl ether, polyethylene glycol dialkyl ether, polypropylene glycol dialkyl ether, acetonitrile, propionitrile, benzonitrile, carboxylic acid ester, phosphoric acid ester, phosphonic acid ester, dimethyl sulfoxide, sulfolane, dimethylformamide, dimethylacetamide, ethyl acetate, chloroform, methylene chloride, and methyl acetate.

The content of the organic solvent in the kneaded material is preferably 0.1% by mass or less and more preferably 0.01% by mass or less. It is particularly preferable that the kneaded material according to the embodiment of the present invention does not contain an organic solvent.

### Other Additives

The kneaded material according to the embodiment of the present invention may appropriately contain optional additives such as an antioxidant, a light stabilizer, a processing stabilizer, an anti-aging agent, a polymerization inhibitor, a flame retardant, and an antistatic agent as necessary.

### Applications

The kneaded material according to the embodiment of the present invention can also be suitably used for applications in a case where the kneaded material may be exposed to light including sunlight and ultraviolet rays. Specific examples include coating materials or films for window glass of houses, facilities, and transportation equipment; interior/exterior materials of houses, facilities, and transportation equipment; members for light sources that emit ultraviolet rays, such as a fluorescent lamp and a mercury lamp; solar cells, precision machineries, electronic and electrical equipment, and members for a display device; containers or packaging materials for food, chemicals, and drugs; agricultural and industrial sheets; clothing textile products and fibers such as sportswear, stockings, and hats; lenses such as plastics lenses, contact lenses, glasses, and artificial eyes, or coating materials thereof; optical supplies such as optical filters, prisms, mirrors, and photographic materials; stationery such as tapes; and marking boards, marking devices, and the surface coating materials thereof. For the details thereof, the description in paragraphs 0158 to 0218 of JP2009-263617A can be referred to, and the contents thereof are incorporated in the present specification.

The kneaded material according to the embodiment of the present invention can be preferably used for an optical member or the like. For example, the kneaded material according to the embodiment of the present invention is preferably used as a kneaded material for an ultraviolet cut filter, a lens, a protective material, or the like. The form of the protective material is not particularly limited, and examples thereof include a coating film, a film, and a sheet.

The kneaded material according to the embodiment of the present invention can also be used for various members of a display device. For example, in a case of a liquid crystal display device, the resin composition can be used for each member constituting the liquid crystal display device such as an antireflection film, a polarizing plate protective film, an optical film, a retardation film, a pressure sensitive adhesive, and an adhesive.

### Method of Producing Kneaded Material

A method of producing the kneaded material according to the embodiment of the present invention includes a step (kneading step) of kneading an ultraviolet absorbing agent that contains at least one compound selected from a compound represented by Formula (1) or a compound represented by Formula (2) with a polymer compound.

In the kneading step, it is preferable that the ultraviolet absorbing agent, the polymer compound, and, as necessary, other materials used for a kneaded material are mixed and the obtained mixture is kneaded. A known device such as a Banbury mixer, a twin screw extruder, a single screw extruder, a rotor type twin screw kneader, or a kneader can be used for kneading. Further, the kneading is performed preferably at a kneading temperature higher than the glass transition point of the polymer compound.

The kneaded material after the kneading step can be processed into a predetermined shape (for example, a pellet shape) as necessary.

Further, the kneaded material in a melting state can be molded into various shapes to obtain a molded body. For example, an unstretched resin film can be obtained by extruding the kneaded material in a melting state to a cooling roll through a die and cooling and solidifying the kneaded material. Examples of the film molding which can be used for forming a resin film include T-die film molding, inflation molding, and calender molding.

### Molded Body and Applications Thereof

Next, a molded body according to the embodiment of the present invention is formed of the above-described kneaded material according to the embodiment of the present invention.

The molded body according to the embodiment of the present invention may be obtained by molding only the kneaded material according to the embodiment of the present invention into a predetermined shape or may be obtained by mixing the kneaded material according to the embodiment of the present invention, a polymer compound, and other additives and molding the mixture into a desired shape. Examples of the polymer compound include the materials described as the polymer compound used in the above-described kneaded material according to the embodiment of the present invention. Examples of the other additives include a plasticizer, a polymerizable monomer, a polymerization initiator, a silane coupling agent, a surfactant, an antioxidant, a light stabilizer, a processing stabilizer, an anti-aging agent, a polymerization inhibitor, a flame retardant, an antistatic agent, and a filler.

The shape of the molded product can be appropriately selected according to the intended use and the purpose. Examples of the shape thereof include a coating film, a film, a sheet, a plate, a lens, a tube, and a fiber.

The molded body according to the embodiment of the present invention is preferably used for an optical member. Examples of the optical member include an ultraviolet cut filter, a lens, and a protective material.

The ultraviolet cut filter can be used for an article such as an optical filter, a display device, a solar cell, or window glass. The kind of display device is not particularly limited, and examples thereof include a liquid crystal display device and an organic electroluminescence display device.

In a case where the molded body according to the embodiment of the present invention is used for a lens, the molded body according to the embodiment of the present invention may be formed into a lens shape and used. Further, the molded body according to the embodiment of the present invention may be used for a coating film on a surface of a lens, an interlayer of a cemented lens, or the like. Examples of the cemented lens include those described in paragraphs 0094 to 0102 of WO2019/131572A, and the contents of which are incorporated in the present specification.

The kind of the protective material is not particularly limited, and examples thereof include a protective material for a display device, a protective material for a solar cell, a protective material for window glass, and an organic electroluminescence display device. The shape of the protective material is not particularly limited, and examples thereof include a coating film, a film, and a sheet.

### Optical Member

An optical member according to the embodiment of the present invention contains the above-described molded body according to the embodiment of the present invention. Examples of the optical member include an ultraviolet cut filter, a lens, and a protective material.

The ultraviolet cut filter can be used for an article such as an optical filter, a display device, a solar cell, or window glass. The kind of display device is not particularly limited, and examples thereof include a liquid crystal display device and an organic electroluminescence display device.

Examples of the lens include those obtained by forming the molded body according to the embodiment of the present invention into a lens shape and those obtained by using the molded body according to the embodiment of the present invention for a coating film on a surface of a lens, an interlayer of a cemented lens, or the like.

The kind of the protective material is not particularly limited, and examples thereof include a protective material for a display device, a protective material for a solar cell, and a protective material for window glass. The shape of the protective material is not particularly limited, and examples thereof include a coating film, a film, and a sheet.

The optical member according to the embodiment of the present invention can be preferably used as a constituent member of a display such as a liquid crystal display device (LCD) or an organic electroluminescence display device (OLED).

Examples of the liquid crystal display device include a liquid crystal display device in which a member such as an antireflection film, a polarizing plate protective film, an optical film, or a retardation film contains the molded body according to the embodiment of the present invention. The optical member according to the embodiment of the present invention may be disposed on any of a viewer side (front side) or a backlight side with respect to the liquid crystal cell and any of a side far from the liquid crystal cell (outer) or a side close to the liquid crystal cell (inner) with respect to the polarizer.

Examples of the organic electroluminescence display device include an organic electroluminescence display device in which a member such as an optical film, a polarizing plate protective film in a circularly polarizing plate, or a retardation film such as a quarter wave plate contains the molded body according to the embodiment of the present invention. In a case where such members contain the molded body according to the embodiment of the present invention with the above-described configuration, deterioration of the organic electroluminescence display device due to external light can be suppressed.

### EXAMPLES

Hereinafter, the present invention will be described in more detail with reference to Examples. The materials, the used amounts, the ratios, the treatment contents, the treatment procedures, and the like described in the following examples can be appropriately changed without departing from the gist of the present invention. Therefore, the scope of the present invention is not limited to the following specific examples. In the structural formulae shown below, Me represents a methyl group, Et represents an ethyl group, Bu represents a butyl group, tBu represents a tert-butyl group, Pr represents a propyl group, Ph represents a phenyl group, and Ac represents an acetyl group.

### Synthesis Examples

### Synthesis Example 1 (Synthesis of Compound (1)-52)

An intermediate 1-1 was synthesized according to the following scheme. In the following scheme, the synthesis from p-toluquinone to the intermediate 1-1 was performed using p-toluquinone in place of 2-tert-butyl-1,4-benzoquinone with reference to the method described in paragraph 0176 of JP2016-081035A.

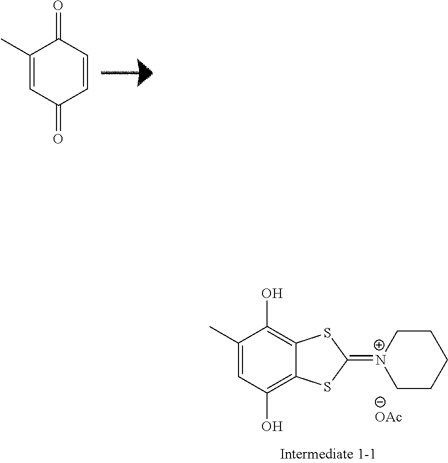

Next, an intermediate 1-3 was synthesized according to the following synthesis scheme. 90 g of the intermediate 1-1, 73.7 g of an intermediate 1-2, and 300 ml of N-methylpyrrolidone were added thereto, mixed, and stirred at 60° C. for 1 hour. After the mixture was cooled to room temperature, 2,700 ml of water was added thereto, and the mixture was stirred for 30 minutes. The precipitated solid was collected by filtration, 300 ml of acetonitrile was added thereto, and the mixture was heated under reflux in a nitrogen atmosphere for 1 hour. The mixture was cooled to room temperature and stirred at room temperature for 1 hour, and the solid was collected by filtration and washed with 150 ml of acetonitrile, thereby obtaining 106 g of an intermediate 1-3 (yield of 85%).

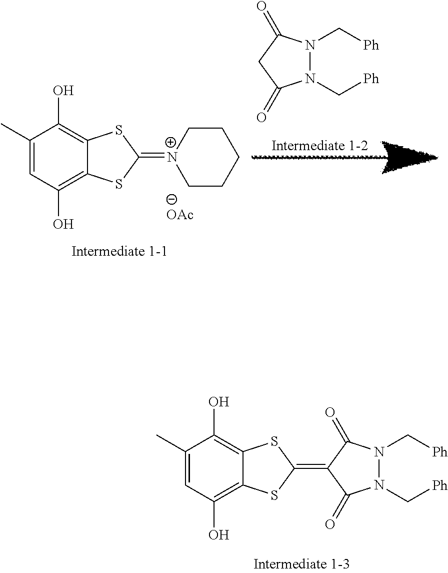 [SMILES: Cc1cc(O)c2sc(=[N+]3CCCCC3)sc2c1O ; O=C1CC(=O)N(Cc2ccccc2)N1Cc1ccccc1 ; Cc1cc(O)c2c(c1O)SC(=C1C(=O)N(Cc3ccccc3)N(Cc3ccccc3)C1=O)S2 ; "OAc"]

4.0 g of the intermediate 1-3, 2.55 g of triethylamine, and 40 ml of N,N-dimethylacetamide were added to a flask, mixed, and stirred in a nitrogen atmosphere under ice-cooling for 10 minutes. 3.82 g of 2-ethylhexanoyl chloride was added to the mixed solution in the flask, and the solution was stirred at room temperature for 3 hours. After the completion of the reaction, the mixture was cooled to room temperature, 20 ml of water was added thereto, and the mixture was stirred for 30 minutes. The precipitated solid was collected by filtration, 50 ml of methanol was added thereto, and the mixture was heated under reflux in a nitrogen atmosphere for 1 hour. The mixture was cooled to room temperature and stirred at room temperature for 1 hour, and the solid was collected by filtration and washed with 25 ml of methanol, thereby obtaining 5.2 g of a compound (1)-52 (yield of 85%).

¹H-NMR (CDCl₃): δ 7.26 (m, 6H), 7.18 (s, 1H), 7.10 (m, 4H), 4.75 (2, 4H), 2.62 (m, 2H), 2.27 (s, 3H), 1.8-1.6 (m, 8H), 1.5-1.3 (m, 8H), 1.10 (m, 6H), 0.94 (m, 6H)

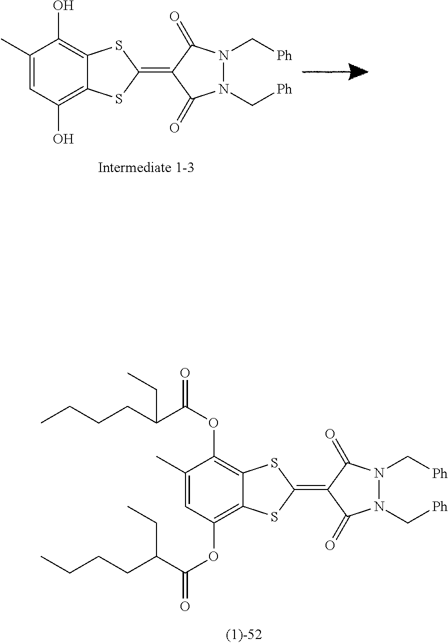 [SMILES: Cc1cc(O)c2c(c1O)SC(=C1C(=O)N(Cc3ccccc3)N(Cc3ccccc3)C1=O)S2 ; CCCCC(CC)C(=O)Oc1cc(C)c(OC(=O)C(CC)CCCC)c2c1SC(=C1C(=O)N(Cc3ccccc3)N(Cc3ccccc3)C1=O)S2]

### Synthesis Example 2 (Synthesis of Compound (1)-46)

A compound (1)-46 was synthesized by the same method as in Synthesis Example 1 except that 2-ethylhexyl bromide was used in place of 2-ethylhexanoyl chloride in Synthesis Example 1.

¹H-NMR (CDCl₃): δ 7.26 (m, 6H) 7.11 (m, 4H), 6.70 (s, 1H), 4.77 (s, 2H), 4.75 (s, 2H), 3.97 (dd, 2H), 3.83 (d, 2H), 2.37 (s, 3H), 1.8-1.6 (m, 18H), 1.0-0.9 (m, 12H)

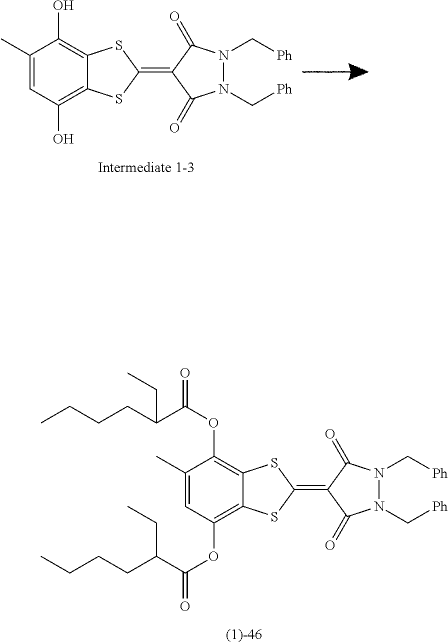 [SMILES: Cc1cc(O)c2c(c1O)SC(=C1C(=O)N(Cc3ccccc3)N(Cc3ccccc3)C1=O)S2 ; CCCCC(CC)C(=O)Oc1cc(C)c(OC(=O)C(CC)CCCC)c2c1SC(=C1C(=O)N(Cc3ccccc3)N(Cc3ccccc3)C1=O)S2]

### Measurement of Maximal Absorption Wavelength (λmax)

A sample solution was prepared by dissolving 2 mg of the compounds listed in the following table in 100 mL of ethyl acetate and diluting the solution with ethyl acetate so that the absorbance of the solution was in a range of 0.6 to 1.2. The absorbance of each sample solution was measured in a 1 cm quartz cell using a spectrophotometer UV-1800PC (manufactured by Shimadzu Corporation). The maximal absorption wavelength (λmax) was measured from the absorption spectrum of each sample solution.

TABLE 1

| Type of compound | λmax (nm) |
|---|---|
| (1)-5 | 383 |
| (1)-8 | 383 |
| (1)-11 | 383 |
| (1)-46 | 387 |
| (1)-49 | 387 |
| (1)-52 | 380 |
| (1)-53 | 382 |
| (1)-69 | 383 |
| (2)-8 | 408 |
| (2)-9 | 410 |
| (2)-11 | 411 |
| (2)-12 | 413 |
| C-1 | 388 |
| C-2 | 351 |
| C-3 | 357 |
| C-4 | 372 |
| C-5 | 352 |
| C-6 | 355 |

(1)-5, (1)-8, (1)-11, (1)-46, (1)-49, (1)-52, (1)-53, (1)-69, (2)-8, (2)-9, (2-11, and (2)-12: compounds having structures shown in specific examples of specific compound described above

C-1 to C-6: compounds having structures shown below (comparative compounds)

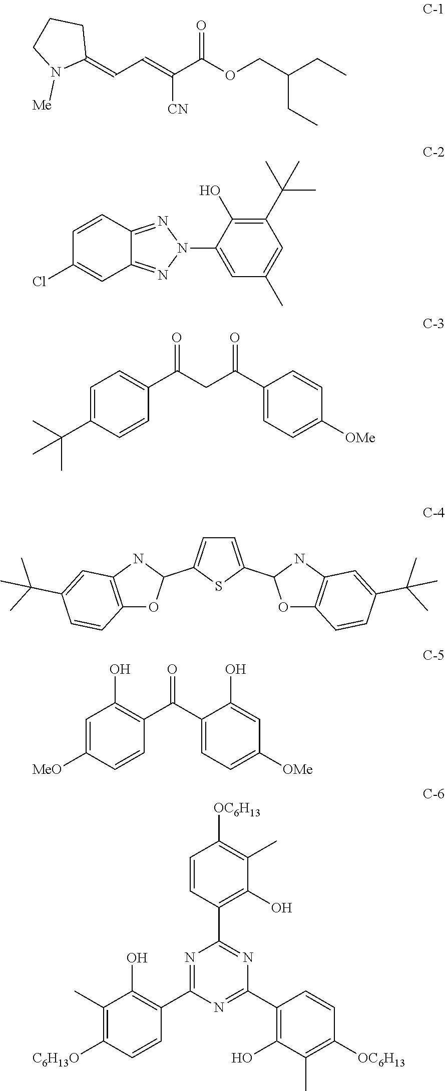

### Test Example 1

1 kg of a polycarbonate resin (SD POLYCA 301-30, manufactured by Sumika Polycarbonate Limited, glass transition point of 145° C. to 150° C.) and the ultraviolet absorbing agent listed in the following table were stirred in a stainless steel tumbler for 1 hour to obtain a mixture. The obtained mixture was melted and kneaded at 280° C. to 320° C. (temperature on an inlet side of the raw material: 280° C., temperature on a discharge side of the kneaded material: 320° C.) for 1 minute using a twin screw kneading extruder (KZW15TW-45/60MG-NH, manufactured by Technovel Corporation), thereby obtaining a pellet-like kneaded material. The obtained pellet-like kneaded material was subjected to a drying treatment at 80° C. for 3 hours and molded with a press machine, thereby preparing a molded plate having a thickness of 0.15 mm.

[Evaluation of Spectral Characteristics]

The transmittance of light having a wavelength of 400 nm, the transmittance of light having a wavelength of 410 nm, and the transmittance of light having a wavelength of 440 nm through the molded plate were respectively measured. The transmittance was measured using a polycarbonate resin to which no ultraviolet absorbing agent was added as a reference.

[Evaluation of Moist Heat Resistance]

The molded plate was subjected to a moist heat resistance test under the following conditions, and the surface of the molded plate was observed to confirm whether or not the surface has unevenness at a bright visual field of 200 times using an optical microscope (BX51, manufactured by Olympus Corporation). Further, the absorption spectrum was observed, and the presence or absence of precipitation of the ultraviolet absorbing agent on the surface was observed.

### —Moist Heat Resistance Test Conditions—

Device: constant-temperature and constant-humidity tank (PR-3KT, manufactured by Espec Corp.)
Environment: 85° C. at relative humidity of 85%
Test period: 500 hours

### —Evaluation Standards—

A: The precipitation of the ultraviolet absorbing agent was not found.
B: The precipitation of the ultraviolet absorbing agent was found.

TABLE 2

| | Ultraviolet | | | | | |
|---|---|---|---|---|---|---|
| | absorbing agent | | | | | |
| | | Addition | Transmittance | | | Moist heat |
| | Type | amount | 400 nm | 410 nm | 440 nm | resistance |
| Example 1-1 | (1)-46 | 1.9 g | 11% | 50% | 100% | A |
| Example 1-2 | (1)-5 | 2.3 g | 10% | 54% | 98% | A |
| Example 1-3 | (1)-52 | 5.2 g | 11% | 60% | 100% | A |
| Example 1-4 | (1)-13 | 1.2 g | 10% | 34% | 91% | A |
| Example 1-5 | (1)-53 | 3.9 g | 10% | 61% | 98% | A |
| Example 1-6 | (2)-8 | 0.73 g | 9% | 11% | 97% | A |
| Example 1-7 | (2)-9 | 0.66 g | 10% | 6% | 96% | A |
| Example 1-8 | (2)-11 | 0.33 g | 10% | 5% | 94% | A |
| Example 1-9 | (2)-12 | 0.99 g | 11% | 2% | 93% | A |
| Example 1-10 | (1)-46 | 0.9 g | 33% | 71% | 100% | A |
| Example 1-11 | (1)-46 | 3.8 g | 3% | 32% | 99% | A |
| Example 1-12 | (1)-46 | 10 g | 10% | 3% | 97% | A |
| Comparative | C-1 | 0.67 g | 40% | 92% | 100% | A |
| example 1-1 | | | | | | |
| Comparative | C-2 | 10 g | 38% | 88% | 100% | B |
| example 1-2 | | | | | | |
| Comparative | C-3 | 10 g | 80% | 100% | 100% | B |
| example 1-3 | | | | | | |
| Comparative | C-4 | 1.25 g | 11% | 61% | 100% | A |
| example 1-4 | | | | | | |

The details of the raw materials described by abbreviations listed in the table above are as follows.

(1)-5, (1)-13, (1)-46, (1)-52, (1)-53, (2)-8, (2)-9, (2)-11, and (2)-12: compounds having structures shown in specific examples of specific compound described above

C-1 to C-4: compounds having structures (comparative compounds) described above

### Test Example 2

1 kg of a polycarbonate resin (SD POLYCA 301-30, manufactured by Sumika Polycarbonate Limited, glass transition point of 145° C. to 150° C.) and the ultraviolet absorbing agent listed in the following table were stirred in a stainless steel tumbler for 1 hour to obtain a mixture. The obtained mixture was melted and kneaded at 280° C. to 320° C. (temperature on an inlet side of the raw material: 280° C., temperature on a discharge side of the kneaded material: 320° C.) for 1 minute using a twin screw kneading extruder (KZW15TW-45/60MG-NH, manufactured by Technovel Corporation), thereby obtaining a pellet-like kneaded material. The obtained pellet-like kneaded material was subjected to a drying treatment at 80° C. for 3 hours and molded with a press machine, thereby preparing a molded plate having a thickness of 0.15 mm.

[Evaluation of Light Resistance]

The molded plate obtained above was subjected to a light resistance test under the following conditions, and the residual rate of the transmittance at the maximal absorption wavelength (λmax) was calculated. Specifically, the transmittance of the molded plate at the maximal absorption wavelength (λmax) was measured, and the light resistance test was carried out under the following conditions. The transmittance of the molded plate after the light resistance test at the maximal absorption wavelength (λmax) was measured, and the residual rate of the transmittance was calculated according to the following equation.

Residual rate (%) of transmittance=100×(100−transmittance of molded plate after light resistance test at λmax)/(100−transmittance of molded plate before light resistance test at λmax)

### —Light Resistance Test Conditions—

Device: Xenon Weather Meter (XL75, manufactured by Suga Test Instruments Co., Ltd.)
Illuminance: 90 klx
Test period: 50 hours
Environment: 23° C. at relative humidity of 50%

[Evaluation of Fluorescence Intensity]

In regard to the molded plate, light having a maximal absorption wavelength of the ultraviolet absorbing agent was used as excitation light to measure an emission spectrum obtained on a longer wavelength side than the maximal absorption wavelength, the maximal fluorescence wavelength and the luminescence intensity at the maximal fluorescence wavelength were measured, and the luminescence intensity at the maximal fluorescence wavelength was determined as the fluorescence intensity, using a fluorescence spectrometer “Spectrophotometer F-7100 (manufactured by Hitachi, Ltd.)”.

TABLE 3

| | | | Light | |
|---|---|---|---|---|
| | | | resistance | |
| | Ultraviolet absorbing agent | | (residual | |
| | | Addition | rate (%) of | Fluorescence |
| | Type | amount | transmittance) | intensity |
| Example 2-1 | (1)-46 | 0.8 g | 95% | 0 |
| Example 2-2 | (1)-5 | 0.8 g | 99% | 0 |
| Example 2-3 | (1)-52 | 0.8 g | 99% | 0 |
| Example 2-4 | (2)-8 | 0.8 g | 100% | 0 |
| Example 2-5 | (2)-9 | 0.8 g | 99% | 0 |
| Example 2-6 | (2)-11 | 0.8 g | 99% | 0 |
| Example 2-7 | (2)-12 | 0.8 g | 98% | 0 |
| Example 2-8 | (1)-46 | 0.5 g | 93% | 0 |
| Example 2-9 | (1)-46 | 1.5 g | 97% | 0 |
| Comparative | C-1 | 0.8 g | 23% | 0 |
| example 2-1 | | | | |
| Comparative | C-2 | 0.8 g | 99% | 4 |
| example 2-2 | | | | |
| Comparative | C-3 | 0.8 g | 6% | 6 |
| example 2-3 | | | | |
| Comparative | C-4 | 0.8 g | 61% | 446 |
| example 2-4 | | | | |

The details of the raw materials described by abbreviations listed in the table above are as follows.

(1)-5, (1)-46, (1)-52, (2)-8, (2)-9, (2)-11, and (2)-12: compounds having structures shown in specific examples of specific compound described above

C-1 to C-4: compounds having structures (comparative compounds) described above

As shown in the results of Test Example 1 and Test Example 2, all examples were excellent in light resistance and moist heat resistance.

### Test Example 3

1 kg of a polycarbonate resin (SD POLYCA 301-30, manufactured by Sumika Polycarbonate Limited, glass transition point of 145° C. to 150° C.) and the ultraviolet absorbing agent listed in the following table were stirred in a stainless steel tumbler for 1 hour to obtain a mixture. The obtained mixture was melted and kneaded at 280° C. to 320° C. (temperature on an inlet side of the raw material: 280° C., temperature on a discharge side of the kneaded material: 320° C.) for 1 minute using a twin screw kneading extruder (KZW15TW-45/60MG-NH, manufactured by Technovel Corporation), thereby obtaining a pellet-like kneaded material. The obtained pellet-like kneaded material was subjected to a drying treatment at 80° C. for 3 hours and molded with a press machine, thereby preparing a molded plate having a thickness of 0.15 mm. The spectral characteristics and the moist heat resistance of the obtained molded plate were evaluated by the same method as in Test Example 1.

TABLE 4

| | Ultraviolet absorbing agent | | | | | | | | |
|---|---|---|---|---|---|---|---|---|---|
| | | Addition | Type | Addition | Transmittance | | | | Moist heat |
| | Type | amount | | amount | 350 nm | 400 nm | 410 nm | 440 nm | resistance |
| Example 3-1 | (1)-46 | 1.9 g | C-2 | 2.3 g | 0% | 10% | 50% | 100% | A |
| Example 3-2 | (1)-46 | 1.9 g | C-5 | 1.3 g | 0% | 9% | 49% | 99% | A |
| Example 3-3 | (1)-46 | 1.9 g | C-6 | 1.7 g | 0% | 9% | 49% | 99% | A |
| Example 3-4 | (1)-52 | 5.2 g | C-2 | 2.3 g | 0% | 10% | 59% | 100% | A |
| Example 3-5 | (1)-52 | 5.2 g | C-5 | 1.3 g | 0% | 11% | 59% | 99% | A |
| Example 3-6 | (1)-52 | 5.2 g | C-6 | 1.7 g | 0% | 10% | 58% | 99% | A |
| Example 3-7 | (1)-5 | 2.3 g | C-2 | 2.3 g | 0% | 9% | 54% | 99% | A |
| Example 3-8 | (1)-5 | 2.3 g | C-5 | 1.3 g | 0% | 10% | 53% | 99% | A |
| Example 3-9 | (1)-5 | 2.3 g | C-6 | 1.7 g | 0% | 9% | 53% | 98% | A |
| Example 3-10 | (2)-8 | 0.73 g | C-2 | 2.3 g | 0% | 9% | 11% | 97% | A |
| Example 3-11 | (2)-8 | 0.73 g | C-5 | 1.3 g | 0% | 9% | 11% | 98% | A |
| Example 3-12 | (2)-8 | 0.73 g | C-6 | 1.7 g | 0% | 8% | 10% | 97% | A |
| Example 3-13 | (2)-12 | 0.99 g | C-2 | 2.3 g | 0% | 10% | 2% | 93% | A |
| Example 3-14 | (2)-12 | 0.99 g | C-5 | 1.3 g | 0% | 10% | 1% | 93% | A |
| Example 3-15 | (2)-12 | 0.99 g | C-6 | 1.7 g | 0% | 9% | 1% | 93% | A |

The details of the raw materials described by abbreviations listed in the table above are as follows.

(1)-5, (1)-46, (1)-52, (2)-8, and (2)-12: compounds having structures shown in specific examples of specific compound described above

C-2, C-5, and C-6: compounds having structures described above (comparative compounds)

As listed in the tables above, the molded plates of Examples 3-1 to 3-15 had satisfactory moist heat resistance.

Further, in a case where the light resistance of the molded plates of Examples 3-1 to 3-15 was evaluated by the same method as in Test Example 2, the molded plates had excellent light resistance.

### Test Example 4

### Examples 4-1 to 4-4

1 kg of a polymethyl methacrylate resin (PMMA) and 0.8 g of the ultraviolet absorbing agent listed in the following table were stirred in a stainless steel tumbler for 1 hour. This mixture was melted and mixed in a vent type extruder at 230° C. to 240° C. to prepare pellets for molding using a method of the related art. The pellets were subjected to a drying treatment at 80° C. for 3 hours and molded with a press machine to prepare a molded plate having a thickness of 0.15 mm. The light resistance of the obtained molded plates was evaluated by the same method as in Test Example 2.

### Examples 4-5 to 4-8

1 kg of pellets of polyethylene terephthalate (PET) dried at 130° C. for 6 hours and 0.8 g of the ultraviolet absorbing agent listed in the following table were stirred in a stainless steel tumbler for 1 hour. This mixture was melted and mixed in a vent type extruder at 265° C. to 280° C. to prepare pellets for molding using a method of the related art. The pellets were subjected to a drying treatment at 80° C. for 3 hours and molded with a press machine to prepare a molded plate having a thickness of 0.15 mm. The light resistance of the obtained molded plates was evaluated by the same method as in Test Example 2.

### Examples 4-9 to 4-12

1 kg of pellets of a cycloolefin polymer (COP) dried at 100° C. for 6 hours and 0.8 g of the ultraviolet absorbing agent listed in the following table were stirred in a stainless steel tumbler for 1 hour. This mixture was melted and mixed in a vent type extruder at 260° C. to 290° C. to prepare pellets for molding using a method of the related art. The pellets were subjected to a drying treatment at 80° C. for 3 hours and molded with a press machine to prepare a molded plate having a thickness of 0.15 mm. The light resistance of the obtained molded plates was evaluated by the same method as in Test Example 2.

### Examples 4-13 to 4-16

1 kg of pellets of Nylon-66 (PA-66) pellets dried at 80° C. for 16 hours and 0.8 g of the ultraviolet absorbing agent listed in the following table were stirred in a stainless steel tumbler for 1 hour. This mixture was melted and mixed in a vent type extruder at 270° C. to 290° C. to prepare pellets for molding using a method of the related art. The pellets were subjected to a drying treatment at 80° C. for 3 hours and molded with a press machine to prepare a molded plate having a thickness of 0.15 mm. The light resistance of the obtained molded plates was evaluated by the same method as in Test Example 2.

### Examples 4-17 to 4-20

1 kg of pellets of polypropylene (PP) and 0.8 g of the ultraviolet absorbing agent listed in the following table were stirred in a stainless steel tumbler for 1 hour. This mixture was melted and mixed in a vent type extruder at 230° C. to 250° C. to prepare pellets for molding using a method of the related art. The pellets were subjected to a drying treatment at 80° C. for 3 hours and molded with a press machine to prepare a molded plate having a thickness of 0.15 mm. The light resistance of the obtained molded plates was evaluated by the same method as in Test Example 2.

TABLE 5

| | Ultraviolet | | Light |
|---|---|---|---|
| | absorbing agent | Resin | resistance |
| Example 4-1 | (1)-46 | PMMA | 96% |
| Example 4-2 | (1)-52 | PMMA | 99% |
| Example 4-3 | (2)-8 | PMMA | 100% |
| Example 4-4 | (2)-11 | PMMA | 99% |
| Example 4-5 | (1)-46 | PET | 96% |
| Example 4-6 | (1)-52 | PET | 99% |
| Example 4-7 | (2)-8 | PET | 100% |
| Example 4-8 | (2)-11 | PET | 99% |
| Example 4-9 | (1)-46 | COP | 96% |
| Example 4-10 | (1)-52 | COP | 99% |
| Example 4-11 | (2)-8 | COP | 100% |
| Example 4-12 | (2)-11 | COP | 99% |
| Example 4-13 | (1)-46 | PA-66 | 95% |
| Example 4-14 | (1)-52 | PA-66 | 99% |
| Example 4-15 | (2)-8 | PA-66 | 100% |
| Example 4-16 | (2)-11 | PA-66 | 99% |
| Example 4-17 | (1)-46 | pp | 96% |
| Example 4-18 | (1)-52 | pp | 99% |
| Example 4-19 | (2)-8 | pp | 100% |
| Example 4-20 | (2)-11 | pp | 99% |

The details of the raw materials described by abbreviations listed in the table above are as follows.

(1)-46, (1)-52, (2)-8, and (2)-11: compounds having structures shown in specific examples of specific compound described above

As listed in the tables above, the molded plates of Examples 4-1 to 4-20 had satisfactory light resistance. The numerical values listed in the columns of light resistance in the tables denote values of the residual rate (%) of the transmittance.

In a case where the moist heat resistance of the molded plates of Examples 4-1 to 4-20 was evaluated by the same method as in Test Example 1, the molded plates had excellent moist heat resistance.

The kneaded materials of the examples can be suitably used for each member constituting a liquid crystal display device or an organic electroluminescence display device.

What is claimed is:

1. A kneaded material comprising:
an ultraviolet absorbing agent that contains at least one compound selected from a compound represented by Formula (1) or a compound represented by Formula (2); and
a polymer compound, 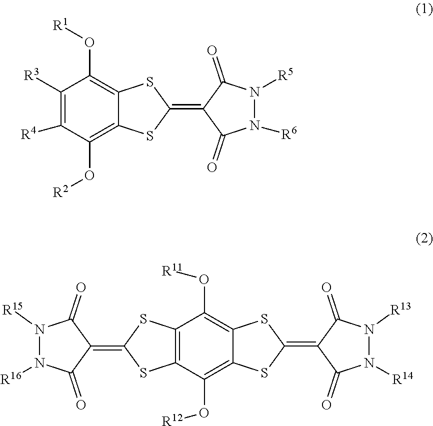
in Formula (1), R¹ and R² each independently represent a hydrogen atom, an alkyl group, an aryl group, an acyl group, a carbamoyl group, an alkoxycarbonyl group, an aryloxycarbonyl group, or an ethylenically unsaturated bond-containing group,
R³ and R⁴ each independently represent a hydrogen atom, a halogen atom, an alkyl group, an aryl group, an alkoxy group, an aryloxy group, an acyloxy group, an alkylamino group, an anilino group, an acylamino group, an alkylsulfonylamino group, an arylsulfonylamino group, an alkylthio group, an arylthio group, or an ethylenically unsaturated bond-containing group,
R⁵ and R⁶ each independently represent a hydrogen atom or a substituent,
R¹ and R³ may be bonded to each other to form a ring,
R³ and R⁴ may be bonded to each other to form a ring,
R² and R⁴ may be bonded to each other to form a ring, and
R⁵ and R⁶ may be bonded to each other to form a ring,
where at least one of R³ or R⁴ represents a halogen atom, an alkyl group, an aryl group, an alkoxy group, an aryloxy group, an acyloxy group, an alkylamino group, an anilino group, an acylamino group, an alkylsulfonylamino group, an arylsulfonylamino group, an alkylthio group, an arylthio group, or an ethylenically unsaturated bond-containing group,
in Formula (2), R¹¹ and R¹² each independently represent a hydrogen atom, an alkyl group, an aryl group, an acyl group, a carbamoyl group, an alkoxycarbonyl group, an aryloxycarbonyl group, or an ethylenically unsaturated bond-containing group,
R¹³, R¹⁴, R¹⁵, and R¹⁶ each independently represent a hydrogen atom or a substituent,
R¹³ and R¹⁴ may be bonded to each other to form a ring, and
R¹⁵ and R¹⁶ may be bonded to each other to form a ring.

2. The kneaded material according to claim 1,
wherein one of R³ and R⁴ in Formula (1) represents a hydrogen atom, and the other represents a halogen atom, an alkyl group, an aryl group, an alkoxy group, an aryloxy group, an acyloxy group, an alkylamino group, an anilino group, an acylamino group, an alkylsulfonylamino group, an arylsulfonylamino group, an alkylthio group, an arylthio group, or an ethylenically unsaturated bond-containing group.

3. The kneaded material according to claim 1, further comprising:
a plasticizer.

4. The kneaded material according to claim 1,
wherein the ultraviolet absorbing agent further contains a compound A having a maximal absorption wavelength on a shorter wavelength side than the compound represented by Formula (1) and the compound represented by Formula (2).

5. The kneaded material according to claim 4,
wherein the compound A is at least one selected from a benzotriazole compound, a triazine compound, or a benzophenone compound.

6. The kneaded material according to claim 1,
wherein the polymer compound has a glass transition point of −80° C. or higher and 200° C. or lower.

7. The kneaded material according to claim 1,
wherein the polymer compound is at least one selected from a (meth)acrylic resin, a polystyrene resin, a polyester resin, a polyurethane resin, a polythiourethane resin, a polyamide resin, a polyimide resin, a cyclic olefin resin, an epoxy resin, a polycarbonate resin, a vinyl polymer, or a cellulose acylate resin.

8. The kneaded material according to claim 1,
wherein the kneaded material is a pellet.

9. A method of producing a kneaded material, comprising:
kneading an ultraviolet absorbing agent that contains at least one compound selected from a compound represented by Formula (1) or a compound represented by Formula (2) with a polymer compound, 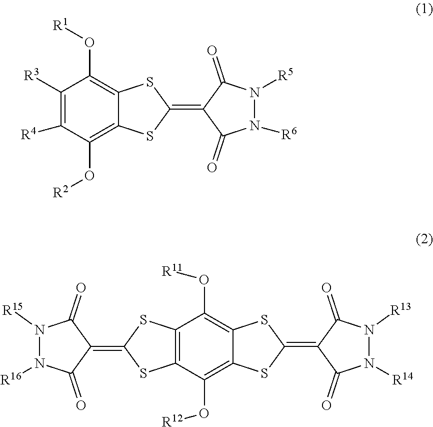
in Formula (1), R¹ and R² each independently represent a hydrogen atom, an alkyl group, an aryl group, an acyl group, a carbamoyl group, an alkoxycarbonyl group, an aryloxycarbonyl group, or an ethylenically unsaturated bond-containing group,
R³ and R⁴ each independently represent a hydrogen atom, a halogen atom, an alkyl group, an aryl group, an alkoxy group, an aryloxy group, an acyloxy group, an alkylamino group, an anilino group, an acylamino group, an alkylsulfonylamino group, an arylsulfonylamino group, an alkylthio group, an arylthio group, or an ethylenically unsaturated bond-containing group,
R⁵ and R⁶ each independently represent a hydrogen atom or a substituent,
R¹ and R³ may be bonded to each other to form a ring,
R³ and R⁴ may be bonded to each other to form a ring,
R² and R⁴ may be bonded to each other to form a ring, and
R⁵ and R⁶ may be bonded to each other to form a ring,
where at least one of R³ or R⁴ represents a halogen atom, an alkyl group, an aryl group, an alkoxy group, an aryloxy group, an acyloxy group, an alkylamino group, an anilino group, an acylamino group, an alkylsulfonylamino group, an arylsulfonylamino group, an alkylthio group, an arylthio group, or an ethylenically unsaturated bond-containing group,
in Formula (2), R¹¹ and R¹² each independently represent a hydrogen atom, an alkyl group, an aryl group, an acyl group, a carbamoyl group, an alkoxycarbonyl group, an aryloxycarbonyl group, or an ethylenically unsaturated bond-containing group,
R¹³, R¹⁴, R¹⁵, and R¹⁶ each independently represent a hydrogen atom or a substituent,
R¹³ and R¹⁴ may be bonded to each other to form a ring, and
R¹⁵ and R¹⁶ may be bonded to each other to form a ring.

10. A molded body formed of the kneaded material according to claim 1.

11. An optical member comprising:
the molded body according to claim 10.
